(19) United States
(12) Patent Application Publication
(10) Pub. No.: US 2026/0194014 A1
(43) Pub. Date: Jul. 9, 2026

(54) GAS TURBINE ENGINE HAVING COMPOSITE FAN BLADES

(71) Applicant: General Electric Company, Evendale, OH (US)

(72) Inventors: Arthur William Sibbach, Boxford, MA (US); Gary Willard Bryant, JR., Loveland, OH (US)

(21) Appl. No.: 19/558,713

(22) Filed: Mar. 6, 2026

Related U.S. Application Data
(63) Continuation-in-part of application No. 19/362,542, filed on Oct. 20, 2025.
Application No. 19/362,542 is a continuation of application No. 18/909,259, filed on Oct. 8, 2024, now Pat. No. 12,473,863.
Application No. 18/909,259 is a continuation-in-part of application No. 18/603,773, filed on Mar. 13, 2024, now Pat. No. 12,473,832.

(51) Int. Cl. F02C 7/36

(52) U.S. Cl. CPC F02C 7/36; F05D 2220/36; F05D 2260/4031

(57) ABSTRACT

A gas turbine engine includes: a turbomachine comprising a drive turbine and defining a working gas flowpath and an inlet to the working gas flowpath; a fan having a fan blade formed of a composite material, the fan blade defining a leading edge fan radius R_{Fan_LE} and a trailing edge fan radius R_{Fan_TE}, and the fan defining a leading edge hub radius R_{Hub_LE} and a trailing edge hub radius R_{Hub_TE}, the gas turbine engine defining a bypass ratio during operation of the gas turbine engine in a cruise operating mode; and a reduction gearbox mechanically coupling the drive turbine of the turbomachine to the fan; wherein the gas turbine engine defines a Fan Leading Edge to Trailing Edge Compression Factor (FLTCF) greater than or equal to 1.05 and less than or equal to 1.8.

### CROSS-REFERENCE TO RELATED APPLICATIONS

This application is a continuation-in-part of U.S. application Ser. No. 19/362,542, filed Oct. 20, 2025, which is a continuation of U.S. application Ser. No. 18/909,259, filed Oct. 8, 2024, which is a continuation-in-part application of U.S. application Ser. No. 18/603,773 filed Mar. 13, 2024. Each of these applications is hereby incorporated by reference in their entireties.

### FIELD

The present disclosure relates to a gas turbine engine having composite fan blades.

### BACKGROUND

A gas turbine engine typically includes a fan and a turbomachine. The turbomachine generally includes an inlet, one or more compressors, a combustor, and at least one turbine. The compressors compress air which is channeled to the combustor where it is mixed with fuel. The mixture is then ignited for generating hot combustion gases. The combustion gases are channeled to the turbine(s) which extract energy from the combustion gases for powering the compressor(s), as well as for producing useful work to propel an aircraft in flight. The turbomachine is mechanically coupled to the fan for driving the fan during operation.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a cross-sectional view of a gas turbine engine in accordance with an exemplary aspect of the present disclosure.

FIG. 2 is a close-up view of a blade of the gas turbine engine of FIG. 1 in accordance with an exemplary aspect of the present disclosure.

FIG. 3 is a table of example engines of the present disclosure.

FIG. 4 is a cross-sectional view of a gas turbine engine in accordance with another exemplary aspect of the present disclosure.

FIG. 5 is a schematic illustration of a composite airfoil in the form of a fan blade for a turbine engine according to an exemplary embodiment of the present disclosure.

FIG. 6 is a schematic cross-section taken along line III-III of FIG. 5.

FIG. 7 is a schematic enlarged view of an exemplary fan section for a turbine engine according to an exemplary embodiment of the present disclosure.

FIG. 8 is a schematic, cross-sectional view of a forward end of an example gas turbine engine in according with an exemplary embodiment of the present disclosure.

FIG. 9A is a schematic illustration of a composite airfoil and a root of an example fan blade according to an exemplary embodiment of the present disclosure.

FIG. 9B is a detailed view of a portion of the composite airfoil and root of FIG. 9A according to an exemplary embodiment of the present disclosure.

FIG. 9C is another view of the fan blade of FIG. 9B and associated slices or segments according to an exemplary embodiment of the present disclosure.

FIG. 9D is an additional view illustrating measurements of the fan blade of FIGS. 9A-9C according to an exemplary embodiment of the present disclosure.

FIG. 10 is a table summarizing example fan blades.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

The term “at least one of” in the context of, e.g., “at least one of A, B, and C” refers to only A, only B, only C, or any combination of A, B, and C.

The phrases “from X to Y” and “between X and Y” each refers to a range of values inclusive of the endpoints (i.e., refers to a range of values that includes both X and Y).

The term “turbomachine” refers to a machine including one or more compressors, a heat generating section (e.g., a combustion section), and one or more turbines that together generate a torque output.

The terms “low” and “high”, or their respective comparative degrees (e.g., -er, where applicable), when used with a compressor, a turbine, a shaft, or spool components, etc. each refer to relative speeds within an engine unless otherwise specified. For example, a “low turbine” or “low speed turbine” defines a component configured to operate at a rotational speed, such as a maximum allowable rotational speed, lower than a “high turbine” or “high speed turbine” of the engine.

The term “disk loading” refers to an average pressure change across a plurality of rotor blades of a rotor assembly, such as the average pressure change across a plurality of fan blades of a fan.

As used herein, the term “rated speed” with reference to a gas turbine engine refers to a maximum rated speed of the gas turbine engine. For example, in an engine certified by the Federal Aviation Administration (“FAA”), the rated speed refers to a rotation speed of the engine during the highest sustainable and continuous power operation in the certification documents, such as a rotational speed of the gas turbine engine when operating under a maximum continuous operation.

The term “cruise operating mode” (or “cruise condition”) refers to the condition of a gas turbine engine utilized to power an aircraft while operating at a cruise speed when the aircraft levels after climbing to a specified altitude associated with cruise flight. A gas turbine engine may operate at a cruise speed that is from 50% to 90% of a rated speed, such as from 70% to 80% of the rated speed. As used herein, the term “cruise flight” refers to a phase of flight in which an aircraft levels in altitude after a climb phase and prior to descending to an approach phase. In most flight envelopes, the cruise operating mode is exemplified by the operating mode of the gas turbine engine at a midpoint of the particular flight envelope based on a total fuel burn for the flight envelope (i.e., when the gas turbine engine has burned 50% of the total fuel burn for that gas turbine engine during the flight operation).

In various examples, cruise flight may take place at a cruise altitude up to approximately 65,000 feet (ft.). In certain examples, cruise altitude is between approximately 28,000 ft. and approximately 45,000 ft. In yet other examples, cruise altitude is expressed in flight levels (FL) based on a standard air pressure at sea level, in which cruise flight is between FL280 and FL650. In another example, cruise flight is between FL280 and FL450. In still certain examples, cruise altitude is defined based at least on a barometric pressure, in which cruise altitude is between approximately 4.85 psia and approximately 0.82 psia based on a sea-level pressure of approximately 14.70 psia and sea-level temperature at approximately 59 degrees Fahrenheit. In another example, cruise altitude is between approximately 4.85 psia and approximately 2.14 psia. It should be appreciated that, in certain examples, the ranges of cruise altitude defined by pressure may be adjusted based on a different reference sea-level pressure and/or sea-level temperature.

The term “thrust rating” for a gas turbine engine refers to a maximum amount of thrust the gas turbine engine can generate when operating at the rated speed during standard day operating conditions (i.e., sea level under standard temperature and pressure conditions).

As used herein, the term “fan pressure ratio” as it relates to a plurality of fan blades of a fan, refers to a ratio of an air pressure immediately downstream of the fan blades during operation of the fan to an air pressure immediately upstream of the fan blades of the fan during operation of the fan.

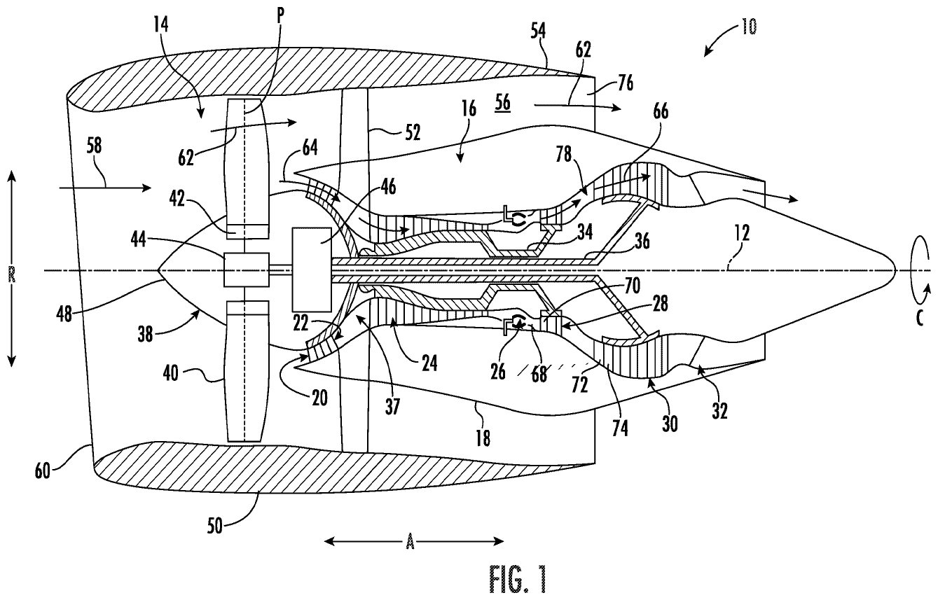

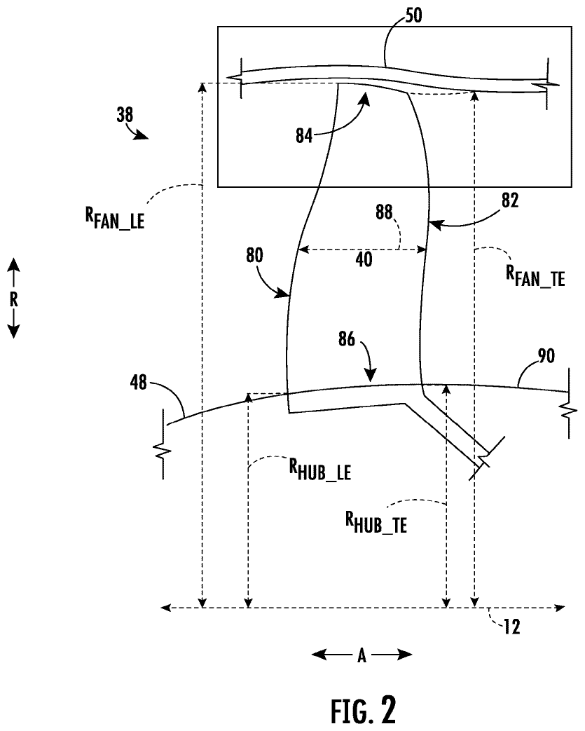

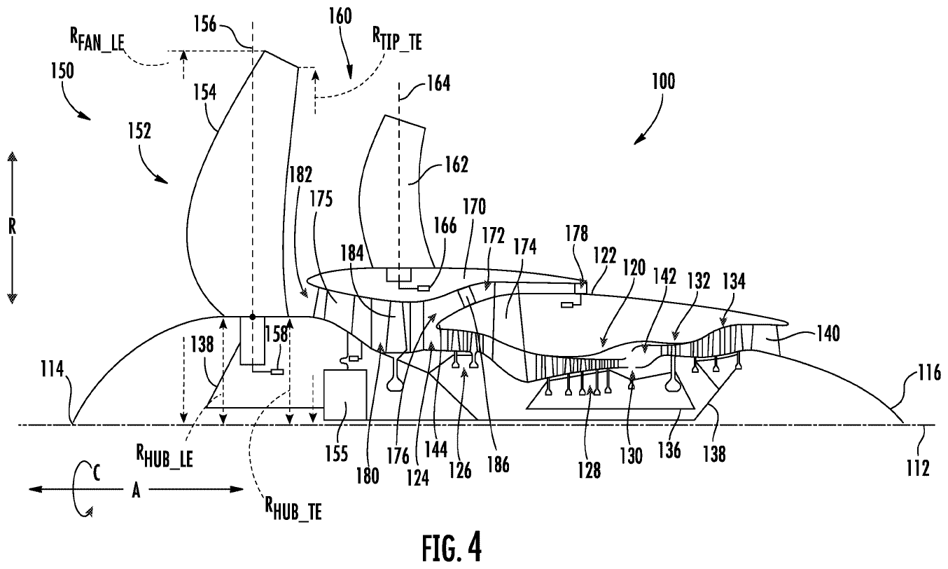

The term “bypass passage” refers generally to a passage with an airflow from a fan of the gas turbine engine that flows over an upstream-most ducted inlet to a turbomachine of the gas turbine engine. In a ducted gas turbine engine, the bypass passage is the passage defined between an outer nacelle (surrounding the fan of the gas turbine engine) and one or more cowls inward of the outer nacelle (e.g., a fan cowl, a core cowl or both if both are present; see, e.g., FIGS. 1 and 2). In an unducted gas turbine engine, the bypass passage refers to an open sided passage (i.e., not explicitly defined by structure such as an outer nacelle) where airflow from the fan passes over an upstream-most inlet to the turbomachine (e.g., inlet 182 to inlet duct 180 in FIG. 4), defined at least in part by a primary fan outer fan area, which refers to an area defined by an annulus representing a portion of the fan located outward of an inlet splitter at the upstream-most inlet to the turbomachine (e.g., inlet splitter of the fan cowl 170 in the embodiment of FIG. 4). An airflow through the bypass passage of a ducted or an unducted engine refers to all of the airflow from the fan that is not provided through the upstream-most inlet to the turbomachine.

The term “bypass ratio” refers to a ratio in a gas turbine engine of a mass flowrate of an airflow from a primary fan through a bypass passage to a mass flowrate of an airflow that passes through the engine's upstream-most ducted inlet. For example, in the embodiment of FIGS. 1, and 4 discussed below, the bypass ratio refers to a mass flowrate of an airflow through the bypass passage (e.g., from a fan 38, 152 that flows over an outer casing 18 or a fan cowl 170) to a mass flowrate of an airflow from the fan 38, 152 that flows through the engine inlet 20, 182. The bypass ratio may be defined during operation of the gas turbine engine in a cruise operating mode.

As used herein, the term “composite material” refers to a material produced from two or more constituent materials, wherein at least one of the constituent materials is a non-metallic material. A composite material is made by combining two or more distinct materials having a finite interface between them. The two or more distinct materials have different chemical and physical properties in relation to one another. One of the two or more distinct materials is the reinforcement (or reinforcing phase), while the other of the two or more distinct materials is the matrix phase.

Example composite materials include polymer matrix composites (PMC), ceramic matrix composites (CMC), and metal matrix composites (MMC).

As used herein, polymer matrix composites or “PMC” refers to a class of materials that include a polymer resin matrix and fibers that are stronger than the matrix, stiffer than the matrix, or both. The fibers may be a variety of materials, nonlimiting examples of which include carbon (e.g., graphite) fibers, glass (e.g., fiberglass) fibers, polymer (e.g., Kevlar®) fibers, basalt fibers, ceramic fibers (e.g. silicon carbide or alumina) and metal fibers. Resins for PMC matrix materials can be generally classified as thermosets or thermoplastics. Thermoplastic resins are generally categorized as polymers that can be repeatedly softened and flowed when heated and hardened when sufficiently cooled due to physical rather than chemical changes. Notable example classes of thermoplastic resins include nylons, thermoplastic polyesters, polyaryletherketones, and polycarbonate resins. Specific examples of high performance thermoplastic resins that have been contemplated for use in aerospace applications include polyetheretherketone (PEEK), polyetherketoneketone (PEKK), polyetherimide (PEI), and polyphenylene sulfide (PPS). In contrast, once fully cured into a hard rigid solid, thermoset resins do not undergo significant softening when heated but, instead, thermally decompose when sufficiently heated. Notable examples of thermoset resins include epoxy, bismaleimide (BMI), polyesters, vinylesters, phenolics, and polyimide resins.

PMC materials are produced in various forms for different types for manufacturing. PMC manufacturing may be generally classified into two types: (1) prepreg layup where the operators start with materials where the fibers are preimpregnated with resin usually in thin layers which may be placed in a mold and cured to form the part; and (2) infusion where dry fibers are assembled into a preform shape and resin is infused or injected into the dry preform. There are also many subvariants of these two approaches.

Prepregs may be unidirectional fibers impregnated with resin or fabrics with fibers in multiple directions (e.g., woven fabrics, braids, non-crimp fabrics, uniweave fabrics) impregnated with resin and are typically 0.002 inches (in) to 0.050 in thick. Prepregs may come in wide rolls where the manufacturer cuts ply shapes, stack the cut ply shapes into the mold and cure to make the final shape. Prepregs may be slit into narrower widths (e.g., ⅛ in to 12 in) and applied to a mold using automated fiber placement (AFP), then cured to create a final geometry. Prepregs may also be slit and chopped into small chips (e.g., 1 in×2 in, ½ in×1 in, 1 in×1 in), dropped randomly into a mold and cured to make a part.

For infusion, the dry preform may be produced in various ways. Layers of dry woven fabric, braid, and/or non-crimp fabric may be stacked together into a shape. Fibers may be woven into a final shape using 3D weave to create the preform. The resin may also be introduced in various ways. The resin may be introduced via vacuum assisted transfer molding (VARTM) where the dry preform is enclosed in a vacuum bag under vacuum and the resin is introduced into the dry preform under vacuum pressure. Resin transfer molding (RTM) may be used where the preform is placed into a closed mold and the resin is injected into the preform under pressure. As will be appreciated, these are all examples and non-limiting.

As used herein, ceramic-matrix-composite or “CMC” refers to a class of materials that include a reinforcing material (e.g., reinforcing fibers) surrounded by a ceramic matrix phase. Generally, the reinforcing fibers provide structural integrity to the ceramic matrix. Some examples of matrix materials of CMCs can include, but are not limited to, non-oxide silicon-based materials (e.g., silicon carbide, silicon nitride, or mixtures thereof), oxide ceramics (e.g., silicon oxycarbides, silicon oxynitrides, aluminum oxide (Al₂O₃), silicon dioxide (SiO₂), aluminosilicates, or mixtures thereof), or mixtures thereof. Optionally, ceramic particles (e.g., oxides of Si, Al, Zr, Y, and combinations thereof) and inorganic fillers (e.g., pyrophyllite, wollastonite, mica, talc, kyanite, and montmorillonite) may also be included within the CMC matrix.

Some examples of reinforcing fibers of CMCs can include, but are not limited to, non-oxide silicon-based materials (e.g., silicon carbide, silicon nitride, or mixtures thereof), non-oxide carbon-based materials (e.g., carbon), oxide ceramics (e.g., silicon oxycarbides, silicon oxynitrides, aluminum oxide (Al₂O₃), silicon dioxide (SiO₂), aluminosilicates such as mullite, or mixtures thereof), or mixtures thereof.

A centerline of an engine, also referred to as the engine centerline, is an imaginary reference line representing the center of the engine's rotating components.

A hub radius or “Rhub” is measured at the leading edge of a blade from the engine centerline to an outer, distal edge of a hub (also referred to as a disk) to which the blade is attached or otherwise affixed.

A tip radius (Rtip) is measured at the leading edge of a blade from the engine centerline to a tip of the blade.

A span of the blade is a difference between Rtip and Rhub (e.g., Span=Rtip−Rhub).

Leading length or “LL” as used herein refers to a length between a leading edge of the airfoil and a seam between a leading edge protector and a portion of the airfoil.

First leading length or “FLL” as used herein refers to the leading length of a first stage of airfoils.

Second leading length or “SLL” as used herein refers to the leading length of a second stage of airfoils immediately downstream from the first stage of airfoils.

Leading edge protector chord length on the pressure side or “LLP” as used herein refers to the chord length between a leading edge of the airfoil and a seam between a leading edge protector and a portion of the airfoil on the pressure side. The leading edge of the airfoil being defined by a leading edge of the leading edge protector.

Leading edge protector chord length on the suction side or “LLS” as used herein refers to the chord length between a leading edge of the airfoil and a seam between a leading edge protector and a portion of the airfoil on the suction side. The leading edge of the airfoil being defined by a leading edge of the leading edge protector.

Chord length or “CL” as used herein refers to a length (a linear measurement) between a leading edge of the airfoil and a trailing edge of the airfoil.

First chord length or “FCL” as used herein refers to the chord length of the first stage of airfoils.

Second chord length or “SCL” as used herein refers to the chord length of the second stage of airfoils.

Airfoil protection factor or “APF” as used herein refers to a relationship in the form of a ratio of the leading length to the chord length of the airfoil. As more protection is provided for any given airfoil, the leading length increases and in turn so does the APF.

Stage performance factor or “SPF” as used herein refers to a relationship in the form of a ratio of the airfoil protection factor for the first stage of airfoils, or “APF1” to the airfoil protection factor for the second stage of airfoils, or “APF2”.

Chord length pressure side or “CCLP” as used herein refers to a chordwise length of an exposed surface of the airfoil (e.g., the PMC or other composite airfoil) not covered by the leading edge protector on the pressure side of the composite airfoil determined as a difference between CL and LLP (e.g., CCLP=CL−LLP).

Chord length pressure side or “CCLS” as used herein refers to a chordwise length of an exposed surface of the airfoil (e.g., the PMC or other composite airfoil) not covered by the leading edge protector on the suction side of the composite airfoil determined as a difference between CL and LLP (e.g., CCLS=CL−LLS).

That is, CCLP and CCLS refer to an overall length of the airfoil minus the MLE chord length on the pressure side or suction side, respectively.

Standard deviation σ or “STDEV” is a measure of an amount of variation of the values of a variable about a mean value for that variable. The STDEV for leading edge protector chord length to blade chord length is determined by measuring the chord length of the leading-edge protector, and the overall airfoil chord length at periodic intervals (e.g., 1 centimeter) from root to tip of the blade, and calculating the standard deviation of the ratio of the chord lengths.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Generally, a gas turbine engine includes a fan and a turbomachine, with the turbomachine rotating the fan to generate thrust. The turbomachine includes a compressor section, a combustion section, a turbine section, and an exhaust section and defines a working gas flowpath therethrough. With a gas turbine engine, and in particular with a high-bypass gas turbine engine, the gas turbine engine further defines a bypass ratio characterizing a ratio of a mass flowrate of airflow over the turbomachine to a mass flowrate of airflow through the working gas flowpath (more particularly defined above).

In order to provide high levels of thrust in a relatively efficient manner, certain gas turbine engines include a relatively large fan. The inventors of the present disclosure sought out to design a gas turbine engine with a fan having an increased efficiency for a desired overall thrust output of the gas turbine engine.

Conventionally, fan blades are formed of a metal material, which generally provides for desirably thin and light fan blades. In some designs, the thickness of the fan blades drives a hub radius for the fan, which in turn affects an overall size of the fan, as a larger hub radius leads to a larger fan radius for a given thrust design point. While forming the fan blades out of metal is a cost effective manufacturing method that is widely used, the inventors found that a size of the fan blades may be limited with such construction due to the mechanical properties of the metal being used.

In particular, the inventors found that by forming fan blades of the fan out of a composite material, a size of the fan blades could be increased (both in radial length and chord length), as the composite material provides improved strength characteristics over certain metal materials traditionally used for fan blade design. This increase in size, the inventors found, allowed for a reduced fan pressure ratio for a given thrust design point of the gas turbine engine. More specifically, by forming the fan blades out of the composite material, the inventors designed the fan to have a lower solidity and lower fan blade count for the given thrust design point of the gas turbine engine as a result of the increased size of the fan blades.

Conventional design has indicated against such a change in fan blade composition, as forming the fan blades out of composite materials generally results in thicker fan blades, which can be challenging at the hub. However, the inventors found that the lower solidity and lower fan blade count allowed for the fan designed by the inventors to unexpectedly have a lower hub radius (particularly at the leading edge of the fan blades), improving efficiency of the fan at the hub, and allowing for overall shorter fan blades as the fan blades can “start” at a closer radial distance to a centerline of the gas turbine engine.

Further, the inventors of the present disclosure found that by including a reduction gearbox, a rotational speed of the fan may be reduced, further reducing the fan pressure ratio of the fan. While slowing the fan blades down too much can result in a stall at the fan during certain operations, by increasing the size of the fan blades, as is allowed through use of the composite fan blades, the inventors found that the fan may still provide for the desired mass flowrate of airflow thereacross to provide the desired thrust output.

In particular, the inventors discovered, unexpectedly, in the course of designing a gas turbine engine having a fan with composite fan blades, that the costs associated with inclusion of a fan with composite fan blades can be overcome by the aeronautical efficiency benefits to the fan in at least certain designs, contrary to previous thinking and expectations. In particular, the inventors discovered during the course of designing several gas turbine engines having fans with composite fan blades of varying thrust classes and aeronautical efficiency requirements (including the configurations illustrated and described in detail herein), a relationship exists among a leading edge tip radius of a fan blade of the fan, a leading edge hub radius of the fan, a trailing edge tip radius of the fan blade of the fan, and a trailing edge hub radius of the fan, whereby including a fan with composite fan blades in accordance with one or more of the exemplary aspects described herein may result in a net benefit to the overall gas turbine engine design. Notably, the leading edge and trailing edge hub radii (for given leading edge and trailing edge tip radii) are driven by, and correlate to, a solidity and fan blade count of the fan, as lower leading edge and trailing edge hub radii (for given leading edge and trailing edge tip radii) require a fan with a lower solidity and a lower fan blade count.

As briefly noted above, previous thinking was to form fan blades out of metal which avoids the costly process of manufacturing components using composite materials. Manufacturing components out of composite materials is either very labor intensive or requires significant upfront automation design costs. The inventors unexpectedly found that by forming the fan blades out of a composite material, the updated designs of the fan that are enabled result in gas turbine engines with aeronautical efficiency improvements that outweighed the challenges associated with manufacturing the fan blades using composite materials.

In particular, with a goal of arriving at an improved gas turbine engine capable of providing an improved aeronautical efficiency, the inventors proceeded in the manner of designing gas turbine engines having a fan (with composite fan blades) with various leading edge tip radii, leading edge hub radii, trailing edge tip radii, and trailing edge hub radii; checking an operability and aeronautical efficiency characteristics of the designed gas turbine engines; redesigning the gas turbine engines to vary the noted parameters based on the impact on other aspects of the gas turbine engines; rechecking the operability and aeronautical efficiency characteristics of the redesigned gas turbine engines; etc. during the design of several different types of fans with composite fan blades, including the fans with composite fan blades described herein, which are described below in greater detail.

Referring now to the drawings, wherein identical numerals indicate the same elements throughout the figures, FIG. 1 is a schematic cross-sectional view of a gas turbine engine in accordance with an exemplary embodiment of the present disclosure. More particularly, for the embodiment of FIG. 1, the gas turbine engine is a high-bypass turbofan jet engine, sometimes also referred to as a “turbofan engine.” As shown in FIG. 1, the gas turbine engine 10 defines an axial direction A (extending parallel to a longitudinal centerline 12 provided for reference), a radial direction R, and a circumferential direction C extending about the longitudinal centerline 12. In general, the gas turbine engine 10 includes a fan section 14 and a turbomachine 16 disposed downstream from the fan section 14.

The exemplary turbomachine 16 depicted generally includes a substantially tubular outer casing 18 that defines an annular inlet 20. The outer casing 18 encases, in serial flow relationship, a compressor section including a booster or low pressure (LP) compressor 22 and a high pressure (HP) compressor 24; a combustion section 26; a turbine section including a high pressure (HP) turbine 28 and a low pressure (LP) turbine 30; and a jet exhaust nozzle section 32. A high pressure (HP) shaft 34 (which may additionally or alternatively be a spool) drivingly connects the HP turbine 28 to the HP compressor 24. A low pressure (LP) shaft 36 (which may additionally or alternatively be a spool) drivingly connects the LP turbine 30 to the LP compressor 22. The compressor section, combustion section 26, turbine section, and jet exhaust nozzle section 32 together define a working gas flowpath 37.

For the embodiment depicted, the fan section 14 includes a fan 38 having a plurality of fan blades 40 coupled to a disk 42 in a spaced apart manner. As depicted, the fan blades 40 extend outwardly from disk 42 generally along the radial direction R. Each fan blade 40 is rotatable relative to the disk 42 about a pitch axis P by virtue of the fan blades 40 being operatively coupled to a suitable pitch change mechanism 44 configured to collectively vary the pitch of the fan blades 40, e.g., in unison. The gas turbine engine 10 further includes a power gear box 46, and the fan blades 40, disk 42, and pitch change mechanism 44 are together rotatable about the longitudinal centerline 12 by LP shaft 36 across the power gear box 46. The power gear box 46 includes a plurality of gears for adjusting a rotational speed of the fan 38 relative to a rotational speed of the LP shaft 36, such that the fan 38 may rotate at a more efficient fan speed.

Referring still to the exemplary embodiment of FIG. 1, the disk 42 is covered by rotatable front hub 48 of the fan section 14 (sometimes also referred to as a “spinner”). The front hub 48 aerodynamically contoured to promote an airflow through the plurality of fan blades 40.

Additionally, the exemplary fan section 14 includes an annular fan casing or outer nacelle 50 that circumferentially surrounds the fan 38 and/or at least a portion of the turbomachine 16. It should be appreciated that the nacelle 50 is supported relative to the turbomachine 16 by a plurality of circumferentially-spaced outlet guide vanes 52 in the embodiment depicted. Moreover, a downstream section 54 of the nacelle 50 extends over an outer portion of the turbomachine 16 so as to define a bypass airflow passage 56 therebetween.

During operation of the gas turbine engine 10, a volume of air 58 enters the gas turbine engine 10 through an associated inlet 60 of the nacelle 50 and fan section 14. As the volume of air 58 passes across the fan blades 40, a first portion of air 62 is directed or routed into the bypass airflow passage 56 and a second portion of air 64 as indicated by arrow 64 is directed or routed into the working gas flowpath 37, or more specifically into the LP compressor 22. The ratio between the first portion of air 62 and the second portion of air 64 is commonly known as a bypass ratio. A pressure of the second portion of air 64 is then increased as it is routed through the HP compressor 24 and into the combustion section 26, where it is mixed with fuel and burned to provide combustion gases 66.

The combustion gases 66 are routed through the HP turbine 28 where a portion of thermal and/or kinetic energy from the combustion gases 66 is extracted via sequential stages of HP turbine stator vanes 68 that are coupled to the outer casing 18 and HP turbine rotor blades 70 that are coupled to the HP shaft 34, thus causing the HP shaft 34 to rotate, which supports operation of the HP compressor 24. The combustion gases 66 are then routed through the LP turbine 30 where a second portion of thermal and kinetic energy is extracted from the combustion gases 66 via sequential stages of LP turbine stator vanes 72 that are coupled to the outer casing 18 and LP turbine rotor blades 74 that are coupled to the LP shaft 36, thus causing the LP shaft 36 to rotate, which supports operation of the LP compressor 22 and/or rotation of the fan 38.

The combustion gases 66 are subsequently routed through the jet exhaust nozzle section 32 of the turbomachine 16 to provide propulsive thrust. Simultaneously, the pressure of the first portion of air 62 is substantially increased as the first portion of air 62 is routed through the bypass airflow passage 56 before it is exhausted from a fan nozzle exhaust section 76 of the gas turbine engine 10, also providing propulsive thrust. The HP turbine 28, the LP turbine 30, and the jet exhaust nozzle section 32 at least partially define a hot gas path 78 for routing the combustion gases 66 through the turbomachine 16.

It should be appreciated, however, that the exemplary gas turbine engine 10 depicted in FIG. 1 is by way of example only, and that in other exemplary embodiments, the gas turbine engine 10 may have other configurations. For example, although the gas turbine engine 10 depicted is configured as a ducted gas turbine engine (i.e., including the outer nacelle 50, also referred to herein as a turbofan engine), in other embodiments, the gas turbine engine 10 may be an unducted gas turbine engine (such that the fan 38 is an unducted fan, and the outlet guide vanes 52 are cantilevered from the outer casing 18; see, e.g., FIG. 4; also referred to herein as an open rotor engine). Additionally, or alternatively, although the gas turbine engine 10 depicted is configured as a variable pitch gas turbine engine (i.e., including a fan 38 configured as a variable pitch fan), in other embodiments, the gas turbine engine 10 may alternatively be configured as a fixed pitch gas turbine engine (such that the fan 38 includes fan blades 40 that are not rotatable about a pitch axis P).

Referring now to FIG. 2, a close-up view is provided of the fan 38 of the gas turbine engine 10 of FIG. 1, and in particular of a fan blade 40 of the fan 38 of the gas turbine engine 10 of FIG. 1. The fan blade 40 generally defines a leading edge 80, a trailing edge 82, an outer tip 84 along the radial direction R, a base 86 along the radial direction R, and a chord 88 from the leading edge 80 to the trailing edge 82.

Further, it will be appreciated that the fan 38 defines a leading edge (LE) fan radius RFan_LE of the fan blade 40, a trailing edge (TE) fan radius RFan_TE of the fan blade 40, a leading edge hub radius RHub_LE of the fan 38, and a trailing edge hub radius RHub_TE of the fan 38. The leading edge fan radius RFan_LE of the fan blade 40 is a measure along the radial direction R from the longitudinal centerline 12 of the gas turbine engine 10 to the outer tip 84 of the fan blade 40 at the leading edge 80. The trailing edge fan radius RFan_TE of the fan blade 40 is a measure along the radial direction R from the longitudinal centerline 12 of the gas turbine engine 10 to the outer tip 84 of the fan blade 40 at the trailing edge 82. The leading edge hub radius RHub_LE of the fan 38 is a measure along the radial direction R from the longitudinal centerline 12 of the gas turbine engine 10 to the base 86 of the fan blade 40 at the leading edge 80 (where the leading edge 80 meets the spinner/front hub 48). The trailing edge hub radius RHub_TE of the fan 38 is a measure along the radial direction R from the longitudinal centerline 12 of the gas turbine engine 10 to the base 86 of the fan blade 40 at the trailing edge 82 (where the trailing edge 82 meets a casing 90 defining in part an airflow path to receive airflow from the fan 38).

Further, it will be appreciated that the fan blade 40 (and each of the fan blades 40 of the fan 38) are formed of a composite material. It will be appreciated that as used herein, the phrase “formed of a composite material,” with reference to the fan blades 40, refers to at least 80% by weight of the fan blades 40, between the base 86 and the outer tip 84, being formed of one or more composite materials.

As alluded to earlier, the inventors discovered, unexpectedly during the course of designing gas turbine engines having a fan with composite fan blades—i.e., designing gas turbine engines having a fan (with composite fan blades) with various leading edge tip radii, leading edge hub radii, trailing edge tip radii, and trailing edge hub radii, and evaluating an overall engine and aeronautical efficiency performance—a significant relationship between the leading edge tip radii, leading edge hub radii, trailing edge tip radii, and trailing edge hub radii. The relationship can be thought of as an indicator of the ability of a gas turbine engine having a fan with composite fan blades to be able to provide a desired aeronautical efficiency for a given level of desired thrust output for the gas turbine engine. As will be appreciated, and as discussed above, the leading edge and trailing edge hub radii (for given leading edge and trailing edge tip radii) are driven by, and correlate to, a solidity and fan blade count of the fan, enabled by the formation of the fan blades out of composite materials, as lower leading edge and trailing edge hub radii (for given leading edge and trailing edge tip radii) require a fan with a lower solidity and a lower fan blade count.

The relationship applies to a gas turbine engine having a reduction gearbox to reduce a rotational speed of the fan relative to a driving turbine of a turbomachine of the gas turbine engine, a fan having fan blades formed of a composite material, and a high bypass ratio (i.e., a bypass ratio greater than or equal to 10). The relationship ties together a leading edge tip radius of a fan blade of the fan, a leading edge hub radius of the fan, a trailing edge tip radius of the fan blade of the fan, and a trailing edge hub radius of the fan, as described in more detail herein.

In particular, the inventors discovered that when designing a gas turbine engine, inclusion of a fan having fan blades with a large leading edge tip radius, the fan pressure ratio and rotational speed of the fan may be decreased, resulting generally in more efficiency. However, to avoid stall and generate a desired thrust output, a chord of the fan blades needs to be increased to ensure a sufficient airflow is provided through the fan. As the chord of the fan blade increases, the trailing edge tip radius of the fan blades may also increase to achieve a desired fan pressure ratio. Notably, however, the inventors found that increasing the leading edge tip radius too much resulted in increased weight and drag, offsetting the aerodynamic benefits otherwise achieved.

Further, with the chords of the fan blades increasing, the inventors of the present disclosure found that the solidity and fan blade count of the fan may be reduced, which may in turn result in lower leading edge and trailing edge hub radii (despite an increase in individual fan blade thickness as a result of forming the fan blades with composite materials). However, the inventors of the present disclosure found that the trailing edge hub radii could not be reduced too much without negatively affecting aerodynamics of an airflow into an inlet to the turbomachine, and the leading edge hub radii could not deviate too much from the trailing edge hub radii without negatively affecting a fan pressure ratio of the fan.

The relationship discovered, infra, can therefore identify a gas turbine engine having a fan having fan blades formed of a composite material, a reduction gearbox, and a high bypass ratio capable of achieving a desired aeronautical efficiency, while avoiding a prohibitive drag and weight increases, aerodynamic penalties, or combinations thereof and suited for particular mission requirements, one that takes into account efficiency, weight, structural needs for the fan blades, complexity, reliability, and other factors influencing the optimal choice for a gas turbine engine having a fan having fan blades formed of a composite material, a reduction gearbox, and a high bypass ratio.

In addition to yielding an improved gas turbine engine as noted above, utilizing this relationship, the inventors found that the number of suitable or feasible gas turbine engine designs capable of meeting the above design requirements could be greatly diminished, which facilitates a more rapid down selection of designs to consider as a gas turbine engine is being developed. Such a benefit provides more insight to the requirements for a given gas turbine engine well before specific technologies, integration and system requirements are developed fully. Such a benefit avoids late-stage redesign.

One such relationship providing for improved gas turbine engines, discovered by the inventors, is a Fan Leading Edge to Trailing Edge Compression Factor (FLTCF), expressed as:

$$FLTCF = \frac{{R}_{Fan \_ LE} \times {R}_{Hub \_ TE}}{{R}_{Fan \_ TE} \times {R}_{Hub \_ LE}} . \qquad ( 1 )$$

In the above expression of FLTCG, R_{Fan_LE} is a leading edge fan radius of a fan blade of a fan of a gas turbine engine, R_{Fan_TE} is a trailing edge fan radius of the fan blade of the fan of the gas turbine engine, R_{Hub_LE} is a leading edge hub radius of the fan of the gas turbine engine, and R_{Hub_TE} is a trailing edge hub radius of the fan of the gas turbine engine.

Another such relationship providing for the improved gas turbine engines, discovered by the inventors, is a Fan Leading Edge to Trailing Edge Opening Ratio (FLTOR), expressed as:

$$FLTOR = \frac{{R}_{Fan \_ LE} - {R}_{Hub \_ LE}}{{R}_{Fan \_ TE} - {R}_{Hub \_ TE}} . \qquad ( 2 )$$

In the above expression of FLTCG, R_{Fan_LE} is a leading edge fan radius of a fan blade of a fan of a gas turbine engine, R_{Fan_TE} is a trailing edge fan radius of the fan blade of the fan of the gas turbine engine, R_{Hub_LE} is a leading edge hub radius of the fan of the gas turbine engine, and R_{Hub_TE} is a trailing edge hub radius of the fan of the gas turbine engine.

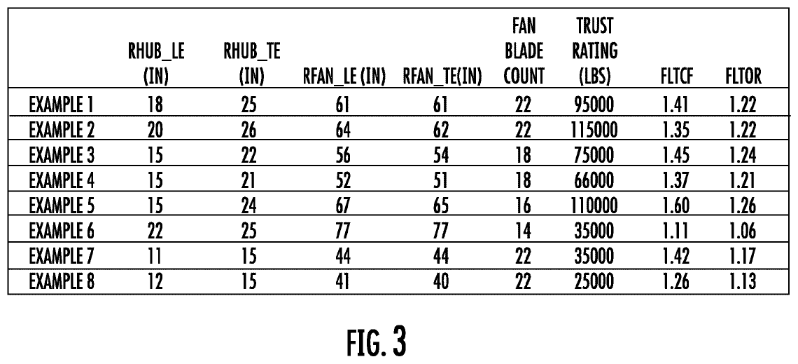

Example engines in accordance with one or more exemplary embodiments of the present disclosure are provided in the table of FIG. 3. The FLTCF is valid only when it is greater than or equal to 1.05 and less than or equal to 1.8. For example, in certain exemplary embodiments, the FLTCF is greater than or equal to 1.07 and less than or equal to 1.65. Further, the FLTOR is valid only when it is greater than or equal to 1.03 and less than or equal to 1.5. For example, in certain exemplary embodiments, the FLTOR is greater than or equal to 1.05 and less than or equal to 1.3. These and other aspects of FLTCF and FLTOR in which these relationships are valid are set forth below in Table 1. FLTCF and FLTOR are not valid outside of the ranges in Table 1.

TABLE 1

| Symbol | Description | FLTCP, FLTOR |
|---|---|---|
| R_{Fan}_LE | Leading edge fan radius of | 20 inches to 85 inches, such |
| | a fan blade of a fan of a gas | as 35 inches to 80 inches |
| | turbine engine | |
| R_{Fan}_TE | Trailing edge fan radius of the | 20 inches to 85 inches, such |
| | fan blade of the fan of the gas | as 35 inches to 68 inches |
| | turbine engine | |
| R_{Hub}_LE | Leading edge hub radius of the | 5 inches to 30 inches, such as |
| | fan of the gas turbine engine | 6 inches to 25 inches |
| R_{Hub}_TE | Trailing edge hub radius of the | 5 inches to 30 inches, such as |
| | fan of the gas turbine engine | 6 inches to 25 inches |
| FLTCF | Fan Leading Edge to Trailing | 1.05 to 1.8, such as 1.07 to |
| | Edge Compression Factor | 1.65 |
| FLTOR | Fan Leading Edge to Trailing | 1.03 to 1.5, such as 1.05 to |
| | Edge Opening Ratio | 1.3 |

Notably, each of exemplary engines noted in FIG. 3 defines a bypass ratio greater than or equal to 10 and less than or equal to 100, such as greater than or equal to 13, such as greater than or equal to 15, and less than or equal to 85, such as less than or equal to 70, such as less than or equal to 25. Further, each of the exemplary engines noted in FIG. 3 includes a reduction gearbox (and thus may be referred to as a geared gas turbine engine) defining a gear ratio greater than or equal to 2 and less than or equal to 14.

For example, in one exemplary embodiment, the gas turbine engine may be an unducted gas turbine engine (also referred to as an “open rotor engine”) including an unducted fan having fan blades formed of a composite material (see, e.g., the embodiment of FIG. 4, described below). In such an exemplary embodiment, a leading edge fan radius R_{Fan_LE} of a fan blade of the fan is greater than or equal to 65 inches and less than or equal to 85 inches, the fan defines a fan blade count greater than or equal to 5 and less than or equal to 15, a reduction gearbox defines a gear ratio greater than 4 and less than 12, and a thrust rating for the engine is between 20,000 pounds and 45,000 pounds. With such an exemplary embodiment the FLTCF is greater than or equal to 1.07 and less than or equal to 1.25, and the FLTOR is greater than or equal to 1.03 and less than or equal to 1.12. In such a manner, it will be appreciated that forming the fan blades of a composite material with this exemplary gas turbine engine enabled a size of the fan (both radially and in a chordwise direction) to be increased, allowing for a desired thrust output, despite a reduction in the fan blade count of the fan and solidity of the fan blades. Example 6 in FIG. 3 is an exemplary embodiment of such a gas turbine engine.

Further for example, in another exemplary embodiment, the gas turbine engine is a ducted gas turbine engine including an outer nacelle surrounding at least in part a fan of the gas turbine engine, with the fan having fan blades formed of a composite material (see, e.g., the embodiment of FIGS. 1 and 2, described above). In such an exemplary embodiment, a leading edge fan radius R_{Fan_LE} of a fan blade of the fan is greater than or equal to 35 inches and less than or equal to 50 inches, the fan defines a fan blade count greater than or equal to 12 and less than or equal to 23, a reduction gearbox defines a gear ratio greater than 2 and less than 4, and a thrust rating for the engine is between 20,000 pounds and 45,000 pounds. With such an exemplary embodiment the FLTCF is greater than or equal to 1.12 and less than or equal to 1.35, and the FLTOR is greater than or equal to 1.06 and less than or equal to 1.19. In such a manner, it will be appreciated that forming the fan blades of a composite material with this exemplary gas turbine engine enabled a size of the fan (e.g., in a chordwise direction) to be increased, allowing for a desired thrust output, despite a potential reduction in the fan blade count of the fan and solidity of the fan blades. Example 8 in FIG. 3 is an exemplary embodiment of such a gas turbine engine.

For example, in yet another exemplary embodiment, the gas turbine engine is a ducted gas turbine engine including an outer nacelle surrounding at least in part a fan of the gas turbine engine, with the fan having fan blades formed of a composite material (see, e.g., the embodiment of FIGS. 1 and 2, described above). In such an exemplary embodiment, a leading edge fan radius R_{Fan_LE} of a fan blade of the fan is greater than or equal to 51 inches and less than or equal to 66 inches, the fan defines a fan blade count greater than or equal to 17 and less than or equal to 23, a reduction gearbox defines a gear ratio greater than 1 and less than 4, and a thrust rating for the engine is between 60,000 pounds and 118,000 pounds. With such an exemplary embodiment the FLTCF is greater than or equal to 1.27 and less than or equal to 1.5, and the FLTOR is greater than or equal to 1.18 and less than or equal to 1.25. In such a manner, it will be appreciated that forming the fan blades of a composite material with this exemplary gas turbine engine enabled a size of the fan (e.g., in a radial direction and in a chordwise direction) to be increased, allowing for a desired thrust output, despite a potential reduction in the fan blade count of the fan and solidity of the fan blades. Examples 1 through 4 in FIG. 3 are exemplary embodiments of such a gas turbine engine.

Further for example, in still another exemplary embodiment, the gas turbine engine is a ducted gas turbine engine including an outer nacelle surrounding at least in part a fan of the gas turbine engine, with the fan having fan blades formed of a composite material (see, e.g., the embodiment of FIGS. 1 and 2, described above). In such an exemplary embodiment, a leading edge fan radius R_{Fan_LE} of a fan blade of the fan is greater than or equal to 55 inches and less than or equal to 70 inches, the fan defines a fan blade count greater than or equal to 12 and less than or equal to 22 (e.g., less than or equal to 19), a reduction gearbox defines a gear ratio greater than 1 and less than 4, and a thrust rating for the engine is between 100,000 pounds and 150,000 pounds (such as greater than 118,000 pounds and less than 150,000 pounds). With such an exemplary embodiment the FLTCF is greater than or equal to 1.46 and less than or equal to 1.65, and the FLTOR is greater than or equal to 1.2 and less than or equal to 1.5 (such as greater than or equal to 1.25 and less than 1.5). In such a manner, it will be appreciated that forming the fan blades of a composite material have enabled a size of the fan (e.g., in a radial direction and in a chordwise direction) to be increased, allowing for a desired thrust output, despite a potential reduction in the fan blade count of the fan and solidity of the fan blades. Example 5 in FIG. 3 is an exemplary embodiment of such a gas turbine engine.

Referring now to FIG. 4, a schematic cross-sectional view of a gas turbine engine 100 is provided according to another example embodiment of the present disclosure. The exemplary gas turbine engine 100 of FIG. 4 may be configured in substantially the same manner as the exemplary gas turbine engine 100 described above with reference to FIGS. 1 and 2.

For example, the exemplary gas turbine engine 100 defines an axial direction A, a radial direction R, and a circumferential direction C. Moreover, the engine 100 defines an axial centerline or longitudinal axis 112 that extends along the axial direction A. In general, the axial direction A extends parallel to the longitudinal axis 112, the radial direction R extends outward from and inward to the longitudinal axis 112 in a direction orthogonal to the axial direction A, and the circumferential direction extends three hundred sixty degrees (360°) around the longitudinal axis 112. The engine 100 extends between a forward end 114 and an aft end 116, e.g., along the axial direction A.

Further, the exemplary gas turbine engine 100 generally includes a fan section 150 and a turbomachine 120. Generally, the turbomachine 120 includes, in serial flow order, a compressor section, a combustion section, a turbine section, and an exhaust section. Particularly, as shown in FIG. 4, the turbomachine 120 includes a core cowl 122 that defines an annular core inlet 124. The core cowl 122 further encloses at least in part a low pressure system and a high pressure system. For example, the core cowl 122 depicted encloses and supports at least in part a booster or low pressure (“LP”) compressor 126; a high pressure (“HP”) compressor 128; a combustor 130; a high pressure turbine 132; and a low pressure turbine 134. The high pressure turbine 132 drives the high pressure compressor 128 through a high pressure shaft 136. The low pressure turbine 134 drives the low pressure compressor 126 and components of the fan section 150 through a low pressure shaft 138, and as such may be referred to as a drive turbine. After driving each of the turbines 132, 134, combustion products exit the turbomachine 120 through a turbomachine exhaust nozzle 140.

Accordingly, the turbomachine 120 defines a working gas flowpath or core duct 142 that extends between the core inlet 124 and the turbomachine exhaust nozzle 140. The core duct 142 is an annular duct positioned generally inward of the core cowl 122 along the radial direction R. The core duct 142 (e.g., the working gas flowpath through the turbomachine 120) may be referred to as a second stream.

The fan section 150 includes a fan 152, which is the primary fan in this example embodiment. By contrast to the embodiment of FIG. 1, for the depicted embodiment of FIG. 4, the fan 152 is an open rotor or unducted fan 152. In such a manner, the gas turbine engine 100 may be referred to as an open rotor engine.

As depicted, the fan 152 includes an array of fan blades 154 (only one shown in FIG. 4). The fan blades 154 are rotatable, e.g., about the longitudinal axis 112. As noted above, the fan 152 is drivingly coupled with the low pressure turbine 134 via the LP shaft 138. As with the exemplary embodiments discussed above, the fan blades 154 are formed of a composite material.

Further for the embodiments shown in FIG. 4, the fan 152 is coupled with the LP shaft 138 via a speed reduction gearbox 155, e.g., in an indirect-drive or geared-drive configuration.

Moreover, the array of fan blades 154 can be arranged in equal spacing around the longitudinal axis 112. Each fan blade 154 has a root and a tip and a span defined therebetween. Each fan blade 154 defines a central blade axis 156. For this embodiment, each fan blade 154 of the fan 152 is rotatable about its central blade axis 156, e.g., in unison with one another. One or more actuators 158 are provided to facilitate such rotation and therefore may be used to change a pitch of the fan blades 154 about their respective central blades' axes 156.

The fan section 150 further includes a fan guide vane array 160 that includes fan guide vanes 162 (only one shown in FIG. 4) disposed around the longitudinal axis 112. For this embodiment, the fan guide vanes 162 are not rotatable about the longitudinal axis 112. Each fan guide vane 162 has a root and a tip and a span defined therebetween. The fan guide vanes 162 may be unshrouded as shown in FIG. 4 or, alternatively, may be shrouded, e.g., by an annular shroud spaced outward from the tips of the fan guide vanes 162 along the radial direction R or attached to the fan guide vanes 162.

Each fan guide vane 162 defines a central blade axis 164. For this embodiment, each fan guide vane 162 of the fan guide vane array 160 is rotatable about its respective central blade axis 164, e.g., in unison with one another. One or more actuators 166 are provided to facilitate such rotation and therefore may be used to change a pitch of the fan guide vane 162 about its respective central blade axis 164. However, in other embodiments, each fan guide vane 162 may be fixed or unable to be pitched about its central blade axis 164. The fan guide vanes 162 are mounted to the fan cowl 170.

By contrast to the embodiment of FIG. 1, as shown in FIG. 4, in addition to the unducted fan 152, a ducted fan 184 is included aft of the fan 152, such that the engine 100 includes both a ducted and an unducted fan which both serve to generate thrust through the movement of air without passage through at least a portion of the turbomachine 120 (e.g., without passage through the HP compressor 128 and combustion section for the embodiment depicted). The ducted fan 184 is rotatable about the same axis (e.g., the longitudinal axis 112) as the fan blade 154. The ducted fan 184 is, for the embodiment depicted, driven by the low pressure turbine 134 (e.g. coupled to the LP shaft 138). In the embodiment depicted, as noted above, the fan 152 may be referred to as the primary fan, and the ducted fan 184 may be referred to as a secondary fan. It will be appreciated that these terms “primary” and “secondary” are terms of convenience, and do not imply any particular importance, power, or the like.

The ducted fan 184 includes a plurality of fan blades (not separately labeled in FIG. 4) arranged in a single stage, such that the ducted fan 184 may be referred to as a single stage fan. The fan blades of the ducted fan 184 can be arranged in equal spacing around the longitudinal axis 112. Each blade of the ducted fan 184 has a root and a tip and a span defined therebetween.

The fan cowl 170 annularly encases at least a portion of the core cowl 122 and is generally positioned outward of at least a portion of the core cowl 122 along the radial direction R. Particularly, a downstream section of the fan cowl 170 extends over a forward portion of the core cowl 122 to define a fan duct flowpath, or simply a fan duct 172. According to this embodiment, the fan flowpath or fan duct 172 may be understood as forming at least a portion of the third stream of the engine 100.

Incoming air may enter through the fan duct 172 through a fan duct inlet 176 and may exit through a fan exhaust nozzle 178 to produce propulsive thrust. The fan duct 172 is an annular duct positioned generally outward of the core duct 142 along the radial direction R. The fan cowl 170 and the core cowl 122 are connected together and supported by a plurality of substantially radially-extending, circumferentially-spaced stationary struts 174 (only one shown in FIG. 4). The stationary struts 174 may each be aerodynamically contoured to direct air flowing thereby. Other struts in addition to the stationary struts 174 may be used to connect and support the fan cowl 170 and/or core cowl 122. In many embodiments, the fan duct 172 and the core duct 142 may at least partially co-extend (generally axially) on opposite sides (e.g., opposite radial sides) of the core cowl 122. For example, the fan duct 172 and the core duct 142 may each extend directly from a leading edge 144 of the core cowl 122 and may partially co-extend generally axially on opposite radial sides of the core cowl 122.

The engine 100 also defines or includes an inlet duct 180. The inlet duct 180 extends between the engine inlet 182 and the core inlet 124/fan duct inlet 176. The engine inlet 182 is defined generally at the forward end of the fan cowl 170 and is positioned between the fan 152 and the fan guide vane array 160 along the axial direction A. The inlet duct 180 is an annular duct that is positioned inward of the fan cowl 170 along the radial direction R. Air flowing downstream along the inlet duct 180 is split, not necessarily evenly, into the core duct 142 and the fan duct 172 by a fan duct splitter or leading edge 144 of the core cowl 122. In the embodiment depicted, the inlet duct 180 is wider than the core duct 142 along the radial direction R. The inlet duct 180 is also wider than the fan duct 172 along the radial direction R.

Moreover, referring still to FIG. 4, in exemplary embodiments, air passing through the fan duct 172 may be relatively cooler (e.g., lower temperature) than one or more fluids utilized in the turbomachine 120. In this way, one or more heat exchangers 186 may be positioned in thermal communication with the fan duct 172. For example, one or more heat exchangers 186 may be disposed within the fan duct 172 and utilized to cool one or more fluids from the core engine with the air passing through the fan duct 172, as a resource for removing heat from a fluid, e.g., compressor bleed air, oil or fuel.

Although not depicted in the example of FIG. 4, the heat exchanger 186 may be an annular heat exchanger extending substantially 360 degrees in the fan duct 172 (e.g., at least 300 degrees, such as at least 330 degrees). In such a manner, the heat exchanger 186 may effectively utilize the air passing through the fan duct 172 to cool one or more systems of the engine 100 (e.g., lubrication oil systems, compressor bleed air, electrical components, etc.). The heat exchanger 186 uses the air passing through duct 172 as a heat sink and correspondingly increases the temperature of the air downstream of the heat exchanger 186 and exiting the fan exhaust nozzle 178.

As will be appreciated from the description herein, various other embodiments of a gas turbine engine are provided. Certain of these embodiments may be an unducted, single rotor gas turbine engine, or a ducted gas turbine engine. Various additional aspects of one or more of these embodiments are discussed below. These exemplary aspects may be combined with one or more of the exemplary gas turbine engine(s) discussed above with respect to the figures.

In one or more of these embodiments, a threshold power or disk loading for a fan (e.g., an unducted single rotor or primary forward fan) may range from 25 horsepower per square foot (hp/ft²) or greater at cruise altitude during a cruise operating mode. In particular embodiments of the engine, structures and methods provided herein generate power loading between 80 hp/ft² and 160 hp/ft² or higher at cruise altitude during a cruise operating mode, depending on whether the engine is an open rotor or ducted engine.

In various embodiments, an engine of the present disclosure is applied to a vehicle with a cruise altitude up to approximately 65,000 ft. In certain embodiments, cruise altitude is between approximately 28,000 ft and approximately 45,000 ft. In still certain embodiments, cruise altitude is expressed in flight levels based on a standard air pressure at sea level, in which a cruise flight condition is between FL280 and FL650. In another embodiment, cruise flight condition is between FL280 and FL450. In still certain embodiments, cruise altitude is defined based at least on a barometric pressure, in which cruise altitude is between approximately 4.85 pounds per square inch absolute (psia) and approximately 0.82 psia based on a sea level pressure of approximately 14.70 psia and sea level temperature at approximately 59 degrees Fahrenheit. In another embodiment, cruise altitude is between approximately 4.85 psia and approximately 2.14 psia. It should be appreciated that in certain embodiments, the ranges of cruise altitude defined by pressure may be adjusted based on a different reference sea level pressure and/or sea level temperature.

In various embodiments, it will be appreciated that the engine includes a ratio of a quantity of vanes to a quantity of blades that could be less than, equal to, or greater than 1:1. For example, in particular embodiments, the engine includes twelve (12) fan blades and ten (10) vanes. In other embodiments, the vane assembly includes a greater quantity of vanes to fan blades. For example, in particular embodiments, the engine includes ten (10) fan blades and twenty-three (23) vanes. For example, in certain embodiments, the engine may include a ratio of a quantity of vanes to a quantity of blades between 1:2 and 5:2. The ratio may be tuned based on a variety of factors including a size of the vanes to ensure a desired amount of swirl is removed for an airflow from the primary fan.

It should be appreciated that various embodiments of the engine, such as the single unducted rotor engine depicted and described herein, may allow for normal subsonic aircraft cruise altitude operation at or above Mach 0.5. In certain embodiments, the engine allows for normal aircraft operation between Mach 0.55 and Mach 0.85 at cruise altitude. In still particular embodiments, the engine allows for normal aircraft operation between Mach 0.75 and Mach 0.85. In certain embodiments, the engine allows for rotor blade tip speeds at or less than 750 feet per second (fps). In other embodiments, the rotor blade tip speed at a cruise flight condition can be 650 to 900 fps, or 700 to 800 fps.

A fan pressure ratio (FPR) for the fan of the fan assembly can be 1.04 to 1.20, or in some embodiments 1.05 to 1.1, or in some embodiments less than 1.08, as measured across the fan blades at a cruise flight condition.

In order for the gas turbine engine to operate with a fan having the above characteristics and provide the benefits noted herein associated with forming the fan blades from a composite material, a gear assembly may be provided to reduce a rotational speed of the fan assembly relative to a driving shaft (such as a low pressure shaft coupled to a low pressure turbine). In some embodiments, a gear ratio of the input rotational speed to the output rotational speed is greater than or equal to 2. For example, in particular embodiments, the gear ratio is within a range of 4.1 to 14.0, within a range of 4.5 to 14.0, or within a range of 6.0 to 14.0. In certain embodiments, the gear ratio is within a range of 4.5 to 12 or within a range of 6.0 to 11.0. As such, in some embodiments, the fan can be configured to rotate at a rotational speed of 700 to 1500 revolutions per minute (rpm) at a cruise flight condition, while the power turbine (e.g., the low-pressure turbine) is configured to rotate at a rotational speed of 2,500 to 15,000 rpm at a cruise flight condition. In particular embodiments, the fan can be configured to rotate at a rotational speed of 850 to 1,350 rpm at a cruise flight condition, while the power turbine is configured to rotate at a rotational speed of 5,000 to 10,000 rpm at a cruise flight condition.

With respect to a turbomachine of the gas turbine engine, the compressors and/or turbines can include various stage counts. As disclosed herein, the stage count includes the number of rotors or blade stages in a particular component (e.g., a compressor or turbine). For example, in some embodiments, a low pressure compressor may include 1 to 8 stages, a high-pressure compressor may include 8 to 15 stages, a high-pressure turbine may include 1 to 2 stages, and/or a low pressure turbine (LPT) may include 3 to 7 stages. In particular, the LPT may have 4 stages, or between 4 and 7 stages. For example, in certain embodiments, an engine may include a one stage low pressure compressor, an 11 stage high pressure compressor, a two stage high pressure turbine, and 4 stages, or between 4 and 7 stages for the LPT. As another example, an engine can include a three stage low-pressure compressor, a 10 stage high pressure compressor, a two stage high pressure turbine, and a 7 stage low pressure turbine.

As discussed above, forming blades out of a composite material results in gas turbine engines with aeronautical efficiency improvement. However, such improvement comes with tradeoffs, and a balance between operability and aeronautical efficiency has been determined by the inventors. Blade count, spacing, etc., factor into efficiency and operability of a gas turbine engine as well as exposure of the engine and its blades to damage, such as from foreign object debris (FOD).

A protective covering, such as a metal covering, can be provided, which is referred to herein as leading edge protector. A metal leading edge protector forms a metal leading edge (MLE). The leading edge protector, such as the MLE protector, allows for use of composite blades by allowing for absorption and/or transfer of forces to the root of the blade, for example.

An amount of protective covering on the leading edge of the airfoil can be designed for various flight conditions, including take off, descent, and idle. One important factor to consider, when designing an airfoil, specifically a composite fan blade and a composite outlet guide vane, is balancing the added weight of the protective covering, or sheath, on the leading edge with a sufficient amount of protection needed for the leading edge (e.g., to protect against damage from FOD). This balance between added weight and leading edge protection is particularly important in large turbofan applications of traditional direct drives, gear-reduction designs, and open-rotor designs. An effective design achieves the right balance between a leading edge dominating the response to a bird ingestion or similar event, while the PMC airfoil dominates the characteristics of blade aerodynamics, e.g. flutter. That is, an effective design is tolerant of a bird strike or impact of other FOD through the leading edge protector while the PMC structure of the airfoil still dominates the aerodynamic response (e.g., reducing or avoiding flutter in the airfoil).

There is a tradeoff between the percentage of the airfoil chord that is covered by the leading edge protector, and the performance of the airfoil. The leading edge protector provides protection to avoid surface damage during a bird strike while the remainder of the blade provides the desired aero-elastic performance properties. If too little of the airfoil is covered with the leading edge protector (e.g., the MLE protector), then the MLE is not strong enough to protect against a bird strike or other FOD impact. However, if too much of the airfoil is covered with the leading edge protector, then the MLE dominates the aerodynamic response of the blade under normal operating conditions, which causes flutter (a negative damping effect).

In a turbine engine, the FOD impact, such as a bird strike and/or other impact, primarily occurs on a pressure side of the blade, with the pressure side receiving a majority of the force of an impact. As such, MLE protection is more extensive on the pressure side than on the suction side. However, a balance of protection and weight must be achieved. If there is too little MLE protection, then the MLE may not be strong enough to protect against a bird strike, particularly in an indirect drive (e.g., geared) engine with fan blades that rotate more slowly than in a direct drive engine and are therefore more likely to suffer a blunt impact from FOD rather than slicing into it. Too little MLE protection can result in separation of the MLE from the composite blade in the event of a bird strike, while too much MLE protection incurs a weight penalty impacting engine operation and specific fuel consumption. If the MLE protector is too long on the suction side of the blade, then the weight of the blade is impacted negatively. If the MLE protector is too long on the pressure side of the blade, then the MLE begins to dominate the aerodynamic response of the blade under normal operating conditions. When the MLE response dominates the PMC response of the airfoil, a negative damping effect or flutter is introduced which negatively impacts engine operation. The inventors have developed a novel blade design that balances these concerns to improve engine operation while avoiding weight penalties, negative damping effects, impact on fan pressure ratio, etc.

The inventors' practice has proceeded in the manner of designing airfoil stages, modifying the +stages with the addition of the leading edge protector, and redesigning the airfoil stages with the leading edge protector meeting protection requirements associated with the airfoil stages. After calculating and checking the amount of protection provided and the amount of weight increase or decreases associated with the leading edge protector, and repeating the process until satisfying a certain architecture and performance requirements, the process is repeated for a different architecture and performance requirement. Examples of these architectures and performance requirements are set forth below. An airfoil design that was found to meet performance requirements for one location in the engine or engine class or type may not necessarily satisfy requirements for another location.

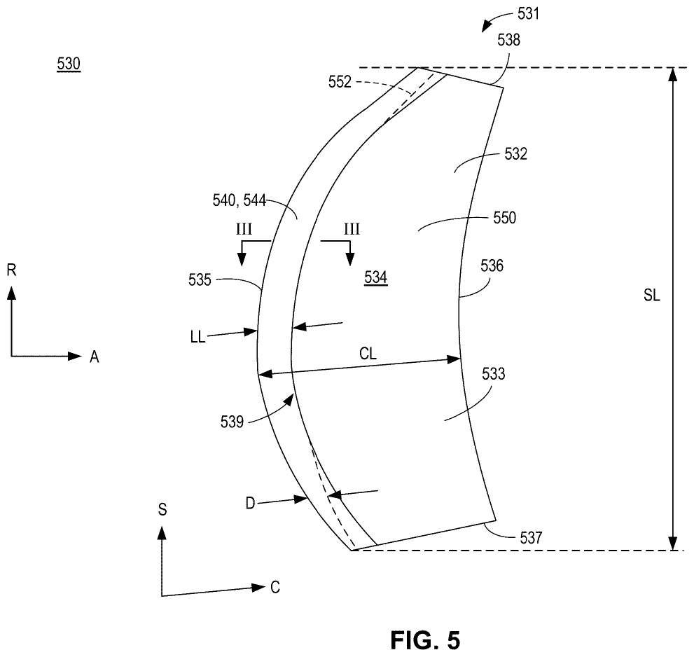

FIG. 5 is a schematic illustration of a composite airfoil 530 in the form of a fan blade 531 of a rotating set of fan blades of a fan section of a gas turbine engine, such as those shown in FIGS. 1 and 4. The composite airfoil 530 can also be an airfoil of outlet guide vanes (OGVs) in a portion of the fan section located downstream of the rotating fan blades.

The composite airfoil 530 can include a wall 532 bounding an interior 533. The wall 532 can define an exterior surface 534 extending radially between a leading edge 535 and a trailing edge 536 to define a chordwise direction (denoted “C”). The composite airfoil 530 has a chord length (denoted “CL”) measured along the chordwise direction C between the leading edge 535 and the trailing edge 536. The exterior surface 534 can further extend between a root 537 and a tip 538 to define a spanwise direction (denoted “S”). The composite airfoil 530 has a spanwise length (denoted “SL”, distinct from the “Span” as defined above and discussed further below) measured along the spanwise direction S between the root 537 and the tip 538 where the root is considered 0% of the spanwise length SL and the tip 538 is considered 100% of the spanwise length SL. The spanwise length SL is the maximum distance between the root 537 and the tip 538 of the composite airfoil 530.

An axial direction (denoted “A”) extends generally across the page from right to left. The axial direction A is parallel to an engine centerline (not shown in this view). A radial direction (denoted “R”) extends perpendicularly away from the axial direction A. It should be understood that the spanwise direction S is parallel to the radial direction R. The chordwise direction C can extend generally along the axial direction A, however with more bend in the composite airfoil 530, it should be understood that the chordwise direction C can extend both into and out of the page and across the page from left to right.

The exterior surface 534 is defined by a leading edge protector 540 and a composite body illustrated as a composite portion 550. An end of the leading edge protector 540 is illustrated as a seam 539. As used herein, the term “seam” refers to an edge or an end of a component where the edge or the end abuts and/or is adjacent to another component (e.g., an end of the leading edge protector 540 adjacent to the composite portion 550, such as where it stops overlapping or overlying the composite portion 550). The seam 539 separates the leading edge protector 540 from the composite portion 550 along the exterior surface 534. The leading edge protector 540 extends along the chordwise direction C between the leading edge 535 and the seam 539 to define a leading length (denoted “LL”).

The leading edge protector 540 is typically a metallic leading edge (MLE) protector and can be made of, but is not limited to, steel (e.g., stainless steel), aluminum, refractory metals such as titanium, or superalloys based on nickel, cobalt, or iron. It should be understood that the leading edge protector 540 for the fan blade 531 can be a metallic leading edge protector while a set of stationary vanes downstream from the fan blade 531, by way of non-limiting example a set of OGVs, have a second leading edge protector made of a polyurethane material. Further, the leading edge protectors 540 described herein can be any suitable material such as metal, thermoplastic, or polyurethane, where both are the same, or different.

The composite portion 550 can include a composite leading edge 552 spaced a distance (denoted “D”) from the leading edge 535. The composite leading edge 552 can define at least a portion of, or all of the seam 539. It is further contemplated that at least a part of the leading edge protector 540 overlaps the composite portion 550 such that at least a portion of, illustrated in dashed line, or all of the composite leading edge 552 is located upstream from the seam 539. In other words, the leading edge protector 540 can define a sheath 544, or protective covering on the composite leading edge 552.

The composite portion 550 can be made of one or more layers of material. The one or more layers of material can be applied during the same stage or different stages of the manufacturing of the composite airfoil 530. By way of non-limiting example, composite portion 550 can include at least a polymer matrix composite (PMC) portion or a polymeric portion. The polymer matrix composite can include, but is not limited to, a matrix of thermoset (epoxies, phenolics) or thermoplastic (polycarbonate, polyvinylchloride, nylon, acrylics) and embedded glass, carbon, steel, or Kevlar fibers.

The leading edge protector 540 and the composite portion 550 can be formed by a variety of methods, including additive manufacturing, casting, electroforming, or direct metal laser melting, in non-limiting examples. As used herein, an “additively manufactured” component refers to a component formed by an additive manufacturing (AM) process, wherein the component is built layer-by-layer by successive deposition of material. AM is an appropriate name to describe the technologies that build 3D objects by adding layer-upon-layer of material, whether the material is plastic, ceramic, or metal. AM technologies can utilize a computer, 3D modeling software (Computer Aided Design or CAD), machine equipment, and layering material. Once a CAD sketch is produced, the AM equipment can read in data from the CAD file and lay down or add successive layers of liquid, powder, sheet material or other material, in a layer-upon-layer fashion to fabricate a 3D object. It should be understood that the term “additive manufacturing” encompasses many technologies including subsets like 3D Printing, Rapid Prototyping (RP), Direct Digital Manufacturing (DDM), layered manufacturing and additive fabrication. Non-limiting examples of additive manufacturing that can be utilized to form an additively-manufactured component include powder bed fusion, vat photopolymerization, binder jetting, material extrusion, directed energy deposition, material jetting, or sheet lamination. It is also contemplated that a process utilized could include printing a negative of the part, either by a refractory metal, ceramic, or printing a plastic, and then using that negative to cast the component.

It will be shown herein that a relationship between the leading length LL and the chord length CL can be referred to herein as an airfoil protection factor or simply as “APF”. In other words, for any given composite airfoil 530 having a predetermined chord length CL, an amount of coverage provided by the leading edge protector 540 increases, so does the leading length LL and in turn the APF.

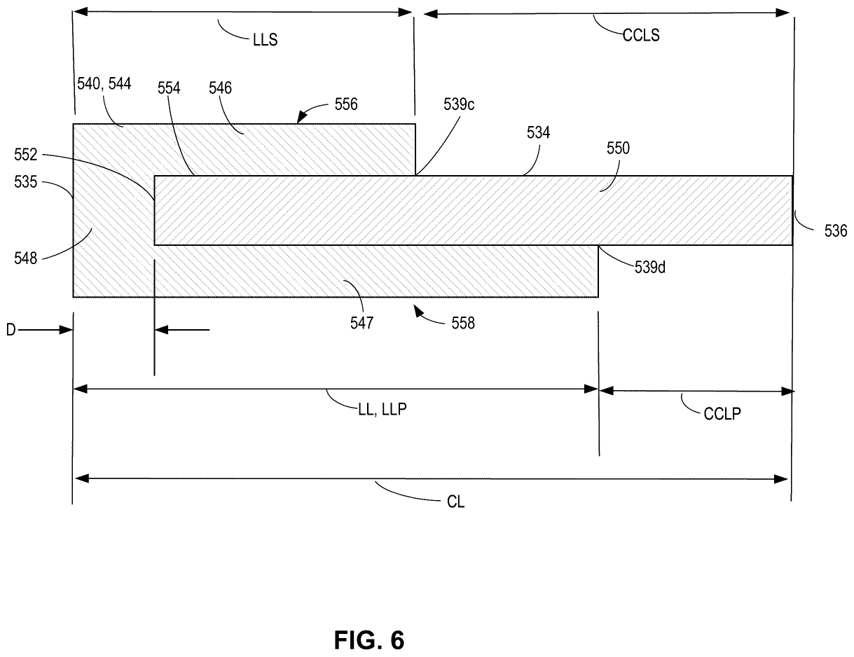

FIG. 6 is a schematic cross-section taken along line III-III of FIG. 5. The leading edge protector 540 is the sheath 544 with a first wall 546, a second wall 547, and a third wall 548 interconnecting the first wall 546 and the second wall 547. The first wall 546, second wall 547, and third wall 548 of the leading edge protector 540 are oriented and shaped such that they define a generally U-shaped (or C-shaped) channel 554 therebetween. As shown in FIG. 6 and as will be discussed below, the channel 554 is sized and shaped to receive the composite leading edge 552 of the composite portion 550. Notably, the shape of the channel 554 is shown by way of example only, and the channel 554 is not limited to this specific shape and is not drawn to scale.

Referring to FIG. 6, the composite airfoil 530 can extend between a first side 556 and a second side 558. The seam 539 can be two seams 539c, 539d at corresponding ends of the channel 554. The leading length LL is measured from the leading edge 535 to the seam 539d furthest from the leading edge 535. While illustrated at two different locations, it should be understood that the seams 539c, 539d can be located at the same leading length LL. While illustrated as rectangular blunt ends at the seam 539, the leading edge protector 540 can taper such that the leading edge protector 540 and the composite portion 550 are flush to define the exterior surface 534.

The LLS is measured on the suction side 556 of the airfoil 530 from the leading edge 535 to the seam 539c. The LLP is measured on the pressure side 558 of the airfoil 530 from the leading edge 535 to the seam 539d. The CCLS is measured from the seam 539c to the trailing edge 536. The CCLP is measured from the seam 539d to the trailing edge 536. As such, the sum of LLS and CCLS equals the chord length CL, and the sum of LLP and CCLP equals CL.

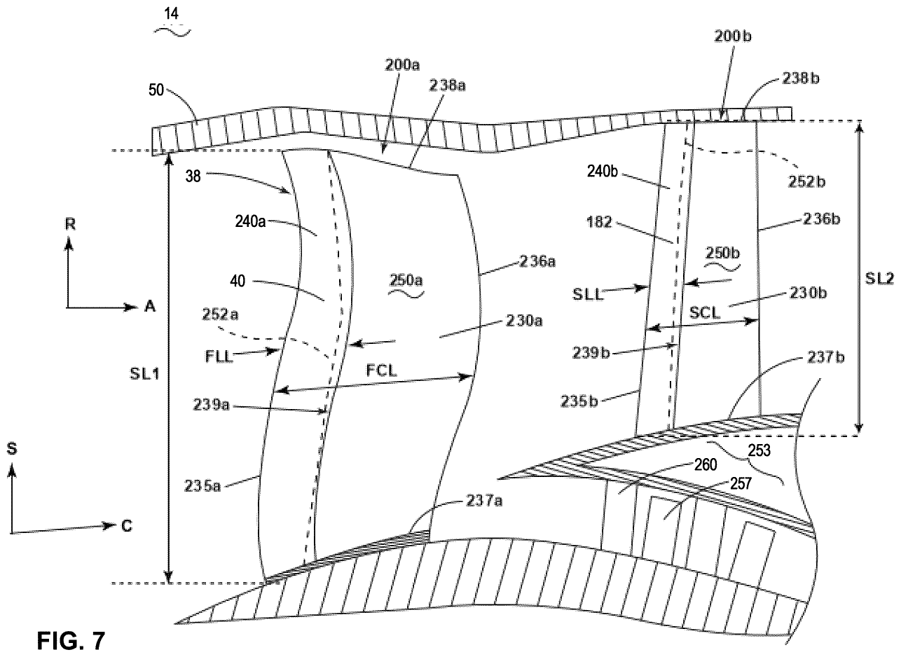

FIG. 7 is a view of a fan section 14 of a ducted gas turbine engine 10. A set of compressor stages 253 includes a set of compressor blades 257 rotating relative to a corresponding set of static compressor vanes 260. A set of fan blades 40 define a fan section 14 including a fan 38. The fan section 14 includes a fan casing 50 surrounding the fan 38.

The set of fan blades 40 defines a first stage of airfoils 200a within the fan section 14. A first airfoil 230a in the first stage of airfoils 200a is shown.

The first airfoil 230a has a first spanwise length (denoted “SL1”) measured along the spanwise direction S between a first root 237a and a first tip 238a where the first root 237a is considered 0% of the first spanwise length SL1 and the first tip 238a is considered 100% of the first spanwise length SL1. The first spanwise length SL1 is the maximum distance between the first root 237a and the first tip 238a of the first airfoil 230a.

A first leading edge protector 240a extends along the chordwise direction C between a first leading edge 235a and a first seam 239a to define a first leading length (denoted “FLL”). The first airfoil 230a has a first chord length (denoted “FCL”) measured along the chordwise direction C between the first leading edge 235a and a first trailing edge 236a.

A relationship between the first leading length (FLL) and the first chord length (FCL) is denoted herein with a first expression of the APF:

$$APF 1 = \frac{FLL}{FCL} . \qquad ( 3 )$$

OGVs 52 define a second stage of airfoils 200b downstream from the first stage of airfoils 200a. A second airfoil 230b in the second stage of airfoils 200b is shown. The second airfoil 230b is located downstream from the first airfoil 230a.

A second leading edge protector 240b extends along the chordwise direction C between a second leading edge 235b and a second seam 239b to define a second leading length (denoted “SLL”). The second airfoil 230b has a second chord length (denoted “SCL”) measured along the chordwise direction C between the second leading edge 235b and a second trailing edge 236b.

The second airfoil 230b has a second spanwise length (denoted “SL2”) measured along the spanwise direction S between a second root 237b and a second tip 238b where the second root 237b is considered 0% of the second spanwise length SL2 and the second tip 238b is considered 100% of the second spanwise length SL2. The second spanwise length SL2 is the maximum distance between the second root 237b and the second tip 238b of the second airfoil 230b.

A relationship between the second leading length (SLL) and the second chord length (SCL) is denoted herein with a second expression of the APF:

$$APF 2 = \frac{SLL}{SCL} . \qquad ( 4 )$$

As will be further discussed herein, the APF describes an amount of protection coverage by the leading edge protector of any of the airfoils 530, 230a, 230b described herein. A balance or trade-off between the amount of protection and the weight gain/loss associated with any of the leading edge protectors described herein can be expressed by an APF value of from 0.1 to 0.3, inclusive of endpoints. In other words, to satisfy protection requirements the leading edge protector described herein should protect at least 10% and up to and including 30% of the leading edge of the composite airfoil before becoming too heavy.

The first stage of airfoils 200a has a first number of airfoils and the second stage of composite airfoils 200b has a second number of airfoils different than the second number. In other words, the consecutive stages of airfoils can vary in size and number of airfoils. Further, the first stage of composite airfoils 200a and the second stage of composite airfoils 200b can both be configured to rotate.

As previously described, the stages of airfoils for a gas turbine engine are depicted by way of example only (e.g., in FIGS. 1 and 4), and, in other exemplary embodiments, the gas turbine engine may have other configurations. For example, although the gas turbine engine can be configured as a ducted gas turbine engine (i.e., including the outer nacelle, also referred to herein as a turbofan engine), in other embodiments, the gas turbine engine is an unducted gas turbine engine (such that the fan is an unducted or open fan, and the outlet guide vanes are cantilevered from the outer casing; also referred to herein as an open rotor engine). Additionally, or alternatively, the gas turbine engine can be configured as a variable pitch gas turbine engine (i.e., including a fan configured as a variable pitch fan), but, in other embodiments, the gas turbine engine is alternatively be configured as a fixed pitch gas turbine engine (such that the fan includes fan blades that are not rotatable about a pitch axis P).

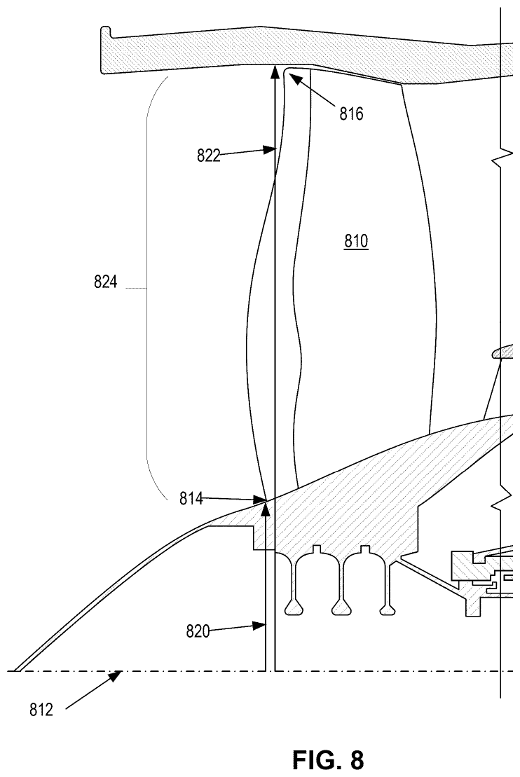

FIG. 8 is a schematic, cross-sectional view of a forward end of an example gas turbine engine. As shown in FIG. 8, a fan blade 810 is attached or otherwise affixed with respect to a hub or disk 814 (e.g., a base or root portion of the blade 810 is attached or otherwise affixed in the hub 814). A hub radius (Rhub) 820 is a distance measured at the leading edge of the blade 810 from an engine centerline 812 to an outer, distal edge of the hub 814 (also referred to as a disk) to which the blade 810 is attached or otherwise affixed. A tip radius (Rtip) 822 is a distance measured at the leading edge of the blade 810 from the engine centerline 812 to a tip 816 of the fan blade 810. A span 824 of the fan blade 810 is then determined by subtracting Rhub from Rtip as follows:

$$Span = Rtip - Rhub . \qquad ( 5 )$$

As will be discussed in further detail below, the fan blade 810 can then be divided into a plurality of equal slices, segments, or cross-sections for measurement and analysis based on the span 824.

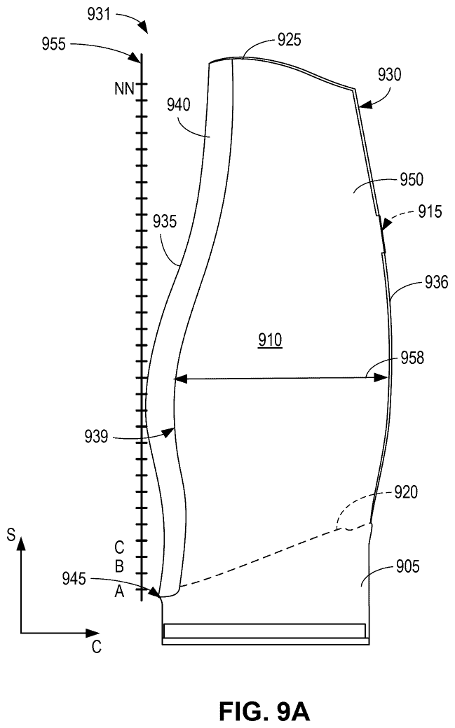

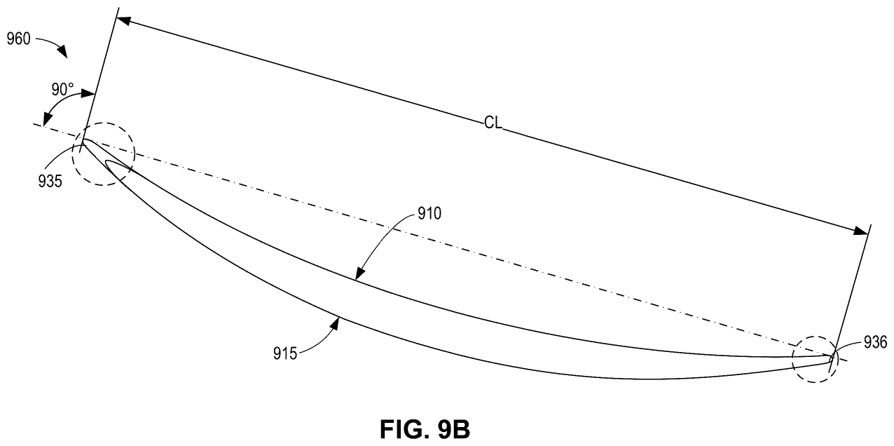

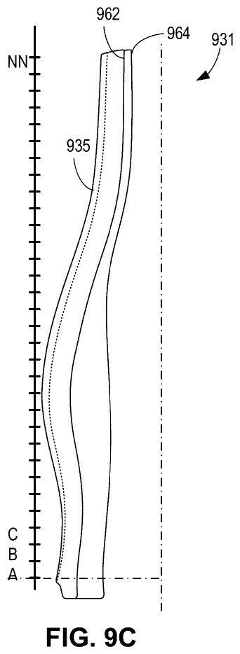

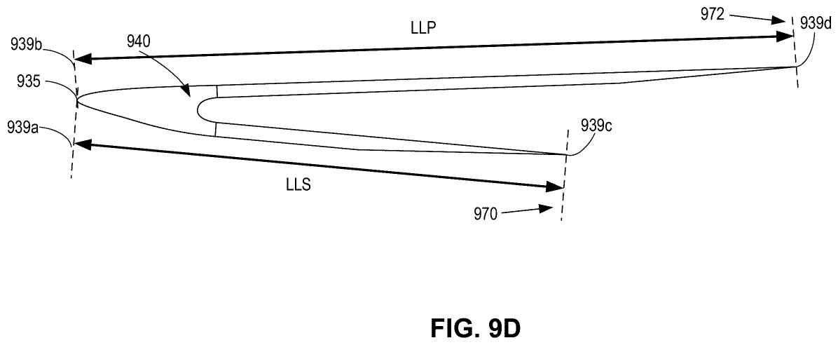

FIG. 9A is a schematic illustration of a composite airfoil 930 and a base or root portion 905 of, by way of non-limiting example, the fan blade 810 of FIG. 8, according to an embodiment of the present disclosure. FIG. 9B is a detailed view of a portion of the composite airfoil 930 and the base or root portion 905 of FIG. 9A according to an exemplary embodiment of the present disclosure. FIG. 9C is another view of the fan blade 931 of FIGS. 9A-9B. In FIG. 9C, slices or segments A, B, C, etc. are indicated, representing discrete span-wise portions of the airfoil. FIG. 9D is an additional view illustrating measurement of LLS and LLP for the fan blade 731. The fan blade 731 can be, by way of non-limiting example, a blade of the set of fan blades 340.

Referring to FIGS. 9A and 9B, the composite airfoil 930 includes a pressure sidewall 910 and a suction sidewall 915 (shown with a dashed line) opposite the pressure sidewall 910. The pressure sidewall 910 and the suction sidewall 915 may define an exterior surface extending radially between a leading edge 935 and a trailing edge 936 in a chordwise direction (denoted “C”). The pressure sidewall 910 and the suction sidewall 915 may further extend between the root portion 905 and a tip 925 in a spanwise direction (denoted “S”). The root 905 is positioned in a hub or disk as indicated by the dashed line 920, which illustrates where the root portion 905 is positioned within the hub or disk, while the airfoil 930 is exposed to the flow of air in the engine. It will be understood that the composite airfoil 930 may take any suitable shape, profile, or form including that the leading edge 935 need not be curved.

The composite airfoil 930 includes a leading edge protector 940 and a composite portion 950. The leading edge protector 940 and the composite portion 950 may be similar or analogous to the exemplary leading edge protectors 540, 240 and the exemplary composite portions 550, 250 discussed above with respect to FIGS. 5-7. For example, a seam 939, separates the leading edge protector 940 from the composite portion 950 along the pressure sidewall 910 and the suction sidewall 915. The leading edge protector 940 extends along the leading edge 935 in the spanwise direction S and extends along the chordwise direction C between the leading edge 935 and the seam 939.

The leading edge protector 940 may be similar or analogous to the exemplary leading edge protectors 540, 240a, and 240b discussed above with respect to FIGS. 5-7. For example, the leading edge protector 940 may be a metallic leading edge protector and can be made of, but is not limited to, steel (e.g., stainless steel), aluminum, refractory metals such as titanium, or superalloys based on nickel, cobalt, or iron.

As shown in the example of FIG. 9A, the fan blade 931 includes the root portion 905 and the composite airfoil 930, delineated by the dashed line 920. The leading edge protector 940 includes at least one projection 945 extending past the composite airfoil 930 towards the root portion 905. For example, the at least one projection 945 extends parallel to the pressure sidewall 910, the suction sidewall 915, and the leading edge 935 from the root portion 905.

As shown in the example of FIG. 9A, the fan blade 931 can be divided along its span 955 (in the spanwise direction S) into a plurality of slices (e.g., slices A to NN each taken at equal thickness (i.e., evenly distributed) through the fan blade 931 in the chordwise direction C). A chord length 958 for the pressure side (CCLP) or suction side (CCLS) can be measured from the corresponding side of the blade 931.

FIG. 9B shows an example slice 960 of the fan blade 931. As shown in the example of FIG. 9B, the chord length CL, representing a length of the leading edge, can be measured. As indicated in FIG. 9B, the measurement CL is taken from the leading edge 935 of the fan blade 931 to the trailing edge 936 in a linear or straight-line measurement, rather than measuring an actual chord of the blade 931. Additional measurements, such as CCLP, CCLS, etc., can then be determined from the chord length CL (minus LLP or LLS depending on whether the pressure side 910 (i.e., the concave side of the airfoil 930) or the suction side 915 (i.e., the convex side of the airfoil 930), respectively, is measured).

FIG. 9C is another view of the example fan blade 931 of FIGS. 9A-9B showing the leading edge 935 and associated slices or segments A-NN. The example of FIG. 9C shows a suction side length 962 of the leading edge 935 and a pressure side length 964 of the leading edge 935. As shown in the example of FIG. 9C, a distance between the leading edge 935 and the suction side length 962 is fairly consistent through the slices A-NN, while a distance between the leading edge 935 and the pressure side length 964 varies according to curvature of the blade 931.

FIG. 9D is an abstracted view of the fan blade 931 illustrating how to measure the length of the leading edge protector 940 as linear length(s) rather than curved length(s). As shown in the example of FIG. 9D, the length of the leading edge protector 940 is a linear length taken from the leading edge 935 to a corresponding end 939c, 939d of the leading edge protector 940. That is, to measure the LLS, the distance from the leading edge 935 to the end 939c of the suction side of the leading edge protector 940 is measured. To measure the LLP, the distance from the leading edge 935 to the end 939d of the pressure side of the leading edge protector 940 is measured.

In various embodiments, it will be appreciated that the engine includes a ratio of a quantity of vanes to a quantity of blades that could be less than, equal to, or greater than 1:1. For example, in particular embodiments, the engine includes twelve (12) fan blades and ten (10) vanes. In other embodiments, the vane assembly includes a greater quantity of vanes to fan blades. For example, in particular embodiments, the engine includes ten (10) fan blades and twenty-three (23) vanes. For example, in certain embodiments, the engine may include a ratio of a quantity of vanes to a quantity of blades between 1:2 and 5:2. The ratio may be tuned based on a variety of factors including a size of the vanes to ensure a desired amount of swirl is removed for an airflow from the primary fan.

It should be appreciated that various embodiments of the engine, such as the single unducted rotor engine depicted and described herein, may allow for normal subsonic aircraft cruise altitude operation at or above Mach 0.5. In certain embodiments, the engine allows for normal aircraft operation between Mach 0.55 and Mach 0.85 at cruise altitude. In still particular embodiments, the engine allows for normal aircraft operation between Mach 0.75 and Mach 0.85. In certain embodiments, the engine allows for rotor blade tip speeds at or less than 750 feet per second (fps). In other embodiments, the rotor blade tip speed at a cruise flight condition can be 650 to 900 fps, or 700 to 800 fps.

It will be understood that a speed reduction device including, but not limited to, a gear assembly may be provided to reduce a rotational speed of the fan assembly relative to the low pressure shaft coupled to a power turbine). In some embodiments, a gear ratio of the input rotational speed to the output rotational speed is greater than or equal to 2. For example, in particular embodiments, the gear ratio is within a range of 4.1 to 14.0, 3.0 to 4.0, 3.2 to 4.0, 5.0 to 7.0, 6.0 to 9.0, or 6.0 to 8.0, within a range of 4.5 to 14.0, or within a range of 6.0 to 11.0. In certain embodiments, the gear ratio is within a range of 4.5 to 12 or within a range of 6.0 to 11.0. As such, in some embodiments, the fan can be configured to rotate at a rotational speed of 700 to 1500 revolutions per minute (rpm) at a cruise flight condition, while the power turbine (e.g., the low-pressure turbine) is configured to rotate at a rotational speed of 2,500 to 15,000 rpm at a cruise flight condition. In particular embodiments, the fan can be configured to rotate at a rotational speed of 850 to 1,350 rpm at a cruise flight condition, while the power turbine is configured to rotate at a rotational speed of 5,000 to 10,000 rpm at a cruise flight condition.

As described above, the gas turbine engine can be a bypass gas turbine engine (e.g., a high-bypass turbofan engine such as the gas turbine engine 10 of the example of FIG. 1). As a volume of air passes across the fan blades, a first portion of air is directed or routed into a bypass airflow passage and a second portion of air is directed or routed into a working gas flow path (e.g., into the LP compressor). The ratio between the first portion of air and the second portion of air is referred to as the bypass ratio. The gas turbine engine can be an indirect drive (i.e., geared) turbofan engine having a bypass ratio greater than or equal to 13:1, for example. For example, the gas turbine engine can be an indirect drive turbofan engine having a bypass ratio of 13:1, 15:1, 20:1, 25:1, 110:1, etc. The gas turbine engine can be an indirect drive turbofan engine having a bypass ratio between 13:1 and 110:1, for example.

The higher the bypass ratio of the gas turbine engine, the greater the percentage of the thrust that is generated by the bypass flow through the fan blades, rather than the core of the gas turbine engine. As the bypass ratio increases, the fan blades are responsible for a greater portion of the work, and, thus, the stress on the blades in normal operating conditions increases. As the workload on the fan blade increases, the composite airfoil must take up the increased stress, while maintaining the integrity of the blade. As described herein, the leading edge protector is combined with the composite airfoil to ensure the proper balance of weight and dynamic response of the blade.

With respect to a turbomachine of the gas turbine engine, the compressors and/or turbines can include various stage counts. As disclosed herein, the stage count includes the number of rotors or blade stages in a particular component (e.g., a compressor or turbine). For example, in some embodiments, a low pressure compressor may include 1 to 8 stages, a high-pressure compressor may include 8 to 15 stages, a high-pressure turbine may include 1 to 2 stages, and/or a low pressure turbine (LPT) may include 3 to 7 stages. In particular, the LPT may have 4 stages, or between 4 and 7 stages. For example, in certain embodiments, an engine may include a one stage low pressure compressor, an 11 stage high pressure compressor, a two stage high pressure turbine, and 4 stages, or between 4 and 7 stages for the LPT. As another example, an engine can include a three stage low-pressure compressor, a 10 stage high pressure compressor, a two stage high pressure turbine, and a 7 stage low pressure turbine.

As discussed above, finding a workable, beneficial solution that balances the amount of protective covering for the composite airfoil as described herein while maintaining a weight requirement is a labor-intensive and time-intensive process, because the process is iterative and involves the selection of multiple composite airfoils with various protector leading edge protector lengths and chord lengths. Design procedures frequently require placing the composite airfoil (e.g., the composite airfoil 530 of FIG. 5, the composite fan blade 931 of FIG. 9A, etc.) into a turbine engine designed for a first flight operating condition and embodying a protection effectiveness with acceptable weight gain/losses for that first flight operating condition. Evaluating whether in a second, third, or other flight operating condition, the same selected composite airfoil maintains a heat effectiveness with acceptable protection effectiveness for the other operating conditions is time-intensive. In some cases, this may even result in a re-design of the composite airfoil and turbine engine if conditions are not met. It is desirable to have an ability to arrive at an improved composite airfoil, like the composite airfoil(s) described herein, rather than relying on chance. It would be desirable to have a limited or narrowed range of possible composite airfoil configurations for satisfying mission requirements, such requirements including protection, weight restrictions, heat transfer, pressure ratio, and noise transmission level requirements, as well as the ability to survive bird strikes at the time the composite airfoil is selected and located within an engine.

As will be appreciated from the description above, the inventors balanced weight and potential negative damping effects of a MLE protector with durability and resistance to blunt force impact to develop an improved leading edge protector. The balance between metal leading edge protector and composite airfoil provides additional rigidity and stability to the fan blade upon foreign object impact.

Accordingly, as disclosed herein, the present disclosure provides a leading edge protector with certain variation in the ratio between the chord of the MLE to the chord of the composite airfoil moving from root/hub to tip of the fan blade, resulting in a gas turbine engine having improved durability and system performance.

The inventors sought to find the trade-off balance between leading edge protection and weight gain/loss while satisfying all design requirements, because this would yield a more desired composite airfoil suited for specific needs of the engine, as described above. Knowing these trade-offs is not only a desirable time saver but is also especially important in a geared, indirect drive turbofan engine, where slower blade rotation exposes the engine to a higher risk of damage from FOD, such as a bird strike.

The inventors determined that certain areas of the blade are most susceptible to a vibratory response if a bird strike or other FOD impact hits a radial location or particular span of the blade. Particularly, the blade has a “sweet spot” or location at which a maximum force is transferred to the bird and to the blade. As developed by the inventors, the MLE for the fan blade is longest in that location.

The inventors developed designs varying MLE protection along a span of the fan blade to provide protection against a bird strike and/or other FOD impact while avoiding weight penalties and vibratory effects that would negatively impact engine operation. In particular, on the pressure side of the airfoil, a ratio of the chord of the MLE (LLP) to the chord of the blade (CL) varies as the airfoil is examined in slices or segments from root to tip. There are areas of the blade that are most susceptible to a vibratory response if that radial location or “slice” along the blade is the location of bird strike or other FOD impact. That is, a force transferred from impact varies depending on the position along the blade in the spanwise direction. The inventors designed fan blades in which the “sweet spot” or location of greatest likelihood (highest probability) for impact is the strongest for the leading edge protector (e.g., the longest MLE chord) to strengthen the blade and protect against damage from bird strike or other FOD. For an indirect drive engine, the “sweet spot” is larger due to the slower speed of fan blade rotation.

Tables 2A-2D below illustrate example composite airfoil configurations (Examples 1-4) that yielded workable, improved, beneficial solutions to provide variation in strength spanwise along a leading edge of a composite fan blade without incurring a weight penalty or generating vibratory effects that negatively impact engine operation. Note that measurements in the tables are provided in centimeters (cm), but the values have been scaled to match inches by dividing by 2.54.

TABLE 2A
Example 1

| Section | CL | LLP | LLS | CCLS | CCLP |
|---|---|---|---|---|---|
| A | 17.26 | 4.01 | 2.38 | 14.88 | 13.25 |
| B | 17.17 | 3.91 | 2.28 | 14.89 | 13.26 |
| C | 16.49 | 3.78 | 2.15 | 14.34 | 12.71 |
| D | 16.02 | 3.76 | 2.13 | 13.89 | 12.26 |
| E | 15.62 | 3.82 | 2.19 | 13.43 | 11.80 |
| F | 14.97 | 3.92 | 2.28 | 12.69 | 11.05 |
| G | 14.61 | 4.07 | 2.38 | 12.23 | 10.54 |
| H | 14.44 | 4.25 | 2.47 | 11.97 | 10.18 |
| J | 14.66 | 5.00 | 2.66 | 12.00 | 9.66 |
| K | 15.38 | 5.81 | 2.86 | 12.52 | 9.57 |
| L | 16.17 | 6.80 | 3.05 | 13.12 | 9.37 |
| M | 17.63 | 7.39 | 3.23 | 14.40 | 10.24 |
| N | 18.86 | 6.95 | 3.38 | 15.48 | 11.91 |
| P | 20.14 | 6.61 | 3.51 | 16.63 | 13.53 |
| R | 21.12 | 5.99 | 3.63 | 17.49 | 15.13 |
| S | 22.00 | 5.49 | 3.73 | 18.27 | 16.52 |
| T | 22.54 | 5.01 | 3.82 | 18.72 | 17.54 |
| U | 22.73 | 4.65 | 3.91 | 18.83 | 18.09 |
| V | 22.90 | 4.50 | 3.98 | 18.92 | 18.40 |
| W | 22.68 | 4.56 | 4.06 | 18.62 | 18.12 |
| X | 22.44 | 4.63 | 4.13 | 18.31 | 17.81 |
| Y | 22.31 | 4.70 | 4.20 | 18.12 | 17.62 |
| Z | 22.30 | 5.00 | 4.90 | 17.40 | 17.30 |
| AA | 22.25 | 5.20 | 5.10 | 17.15 | 17.05 |
| AB | 22.12 | 5.30 | 5.20 | 16.92 | 16.82 |
| AC | 22.11 | 5.70 | 5.60 | 16.51 | 16.41 |

The composite airfoil design of Example 1 includes 22 blades, with an Rhub of 23.5 and an Rtip of 64.05, resulting in a Span of 40.55.

TABLE 2B
Example 2

| Slice | CL | LLP | LLS | CCLS | CCLP |
|---|---|---|---|---|---|
| A | 17.26 | 4.01 | 2.38 | 14.88 | 13.25 |
| B | 17.17 | 3.91 | 2.28 | 14.89 | 13.26 |
| C | 16.49 | 3.78 | 2.15 | 14.34 | 12.71 |
| D | 16.02 | 3.76 | 2.13 | 13.89 | 12.26 |
| E | 15.62 | 3.82 | 2.19 | 13.43 | 11.80 |
| F | 14.97 | 3.92 | 2.28 | 12.69 | 11.05 |
| G | 14.61 | 4.07 | 2.38 | 12.23 | 10.54 |
| H | 14.44 | 4.25 | 2.47 | 11.97 | 10.18 |
| J | 14.66 | 5.00 | 2.66 | 12.00 | 9.66 |
| K | 15.38 | 5.81 | 2.86 | 12.52 | 9.57 |
| L | 16.17 | 6.80 | 3.05 | 13.12 | 9.37 |
| M | 17.63 | 7.39 | 3.23 | 14.40 | 10.24 |
| N | 18.86 | 6.95 | 3.38 | 15.48 | 11.91 |
| P | 20.14 | 6.61 | 3.51 | 16.63 | 13.53 |
| R | 21.12 | 5.99 | 3.63 | 17.49 | 15.13 |
| S | 22.00 | 5.49 | 3.73 | 18.27 | 16.52 |
| T | 22.54 | 5.01 | 3.82 | 18.72 | 17.54 |
| U | 22.73 | 4.65 | 3.91 | 18.83 | 18.09 |
| V | 22.90 | 4.50 | 3.98 | 18.92 | 18.40 |
| W | 22.68 | 4.56 | 4.06 | 18.62 | 18.12 |
| X | 22.44 | 4.63 | 4.13 | 18.31 | 17.81 |
| Y | 22.31 | 4.70 | 4.20 | 18.12 | 17.62 |
| Z | 22.30 | 5.00 | 4.90 | 17.40 | 17.30 |
| AA | 22.25 | 5.20 | 5.10 | 17.15 | 17.05 |
| AB | 22.12 | 5.30 | 5.20 | 16.92 | 16.82 |
| AC | 22.11 | 5.70 | 5.60 | 16.51 | 16.41 |

The composite airfoil design of Example 2 includes 20 blades, with an Rhub of 11 and an Rtip of 35, resulting in a Span of 24.

TABLE 2C
Example 3

| Slice | CL | LLP | LLS | CCLS | CCLP |
|---|---|---|---|---|---|
| A | 17.55 | 3.98 | 2.86 | 14.69 | 13.58 |
| B | 17.27 | 3.96 | 2.87 | 14.40 | 13.31 |
| C | 16.95 | 3.97 | 2.90 | 14.05 | 12.99 |
| D | 16.72 | 3.98 | 2.93 | 13.79 | 12.73 |
| E | 16.61 | 3.99 | 2.96 | 13.66 | 12.62 |
| F | 16.66 | 4.01 | 2.98 | 13.67 | 12.64 |
| G | 16.84 | 4.03 | 3.01 | 13.83 | 12.81 |
| H | 17.16 | 4.10 | 3.05 | 14.12 | 13.06 |
| J | 17.37 | 4.17 | 3.09 | 14.28 | 13.20 |
| K | 17.75 | 4.42 | 3.17 | 14.59 | 13.33 |
| L | 18.18 | 4.89 | 3.28 | 14.90 | 13.30 |
| M | 18.67 | 5.37 | 3.39 | 15.28 | 13.30 |
| N | 19.41 | 5.58 | 3.50 | 15.91 | 13.83 |
| P | 20.18 | 5.77 | 3.60 | 16.58 | 14.41 |
| R | 21.15 | 5.89 | 3.70 | 17.44 | 15.25 |
| S | 22.01 | 6.02 | 3.81 | 18.20 | 15.99 |
| T | 22.68 | 6.11 | 3.93 | 18.75 | 16.58 |
| U | 23.19 | 6.18 | 4.09 | 19.11 | 17.02 |
| V | 23.61 | 6.15 | 4.15 | 19.46 | 17.46 |
| W | 24.02 | 6.17 | 4.19 | 19.83 | 17.85 |
| X | 24.45 | 6.09 | 4.23 | 20.22 | 18.36 |
| Y | 24.87 | 6.07 | 4.29 | 20.59 | 18.81 |
| Z | 25.07 | 6.08 | 4.34 | 20.73 | 18.99 |
| AA | 25.63 | 6.10 | 4.40 | 21.23 | 19.53 |
| AB | 26.11 | 6.17 | 4.50 | 21.61 | 19.93 |
| AC | 27.09 | 6.24 | 4.59 | 22.50 | 20.85 |
| AD | 28.29 | 6.30 | 4.72 | 23.57 | 21.99 |
| AE | 29.00 | 6.34 | 4.87 | 24.14 | 22.67 |
| AF | 29.24 | 6.36 | 4.93 | 24.31 | 22.88 |
| AG | 26.93 | 6.41 | 5.03 | 21.90 | 20.52 |
| AH | 24.02 | 6.50 | 5.20 | 18.83 | 17.53 |
| AJ | 20.31 | 6.62 | 5.39 | 14.92 | 13.69 |

The composite airfoil design of Example 3 includes 16 blades, with an Rhub of 17 and an Rtip of 66.73, resulting in a Span of 49.73.

TABLE 2D
Example 4

| Slice | CL | LLP | LLS | CCLS | CCLP |
|---|---|---|---|---|---|
| A | 5.48 | 1.25 | 1.05 | 4.43 | 4.23 |
| B | 5.52 | 1.28 | 1.08 | 4.44 | 4.25 |
| C | 5.66 | 1.32 | 1.12 | 4.54 | 4.34 |
| D | 5.88 | 1.35 | 1.14 | 4.74 | 4.53 |
| E | 6.13 | 1.38 | 1.18 | 4.95 | 4.74 |
| F | 6.38 | 1.43 | 1.23 | 5.15 | 4.94 |
| G | 6.63 | 1.51 | 1.29 | 5.34 | 5.12 |
| H | 6.74 | 1.61 | 1.36 | 5.38 | 5.13 |
| J | 6.96 | 1.87 | 1.50 | 5.46 | 5.10 |
| K | 7.27 | 2.15 | 1.63 | 5.64 | 5.11 |
| L | 7.62 | 2.36 | 1.72 | 5.90 | 5.27 |
| M | 7.93 | 2.39 | 1.77 | 6.16 | 5.54 |
| N | 8.17 | 2.29 | 1.77 | 6.39 | 5.88 |
| P | 8.35 | 2.25 | 1.74 | 6.61 | 6.10 |
| R | 8.45 | 2.10 | 1.67 | 6.77 | 6.35 |
| S | 8.46 | 2.03 | 1.61 | 6.85 | 6.44 |
| T | 8.44 | 1.97 | 1.57 | 6.87 | 6.47 |
| U | 8.38 | 1.93 | 1.55 | 6.83 | 6.46 |
| V | 8.32 | 1.89 | 1.56 | 6.76 | 6.43 |
| W | 8.27 | 1.86 | 1.57 | 6.69 | 6.41 |
| X | 8.28 | 1.83 | 1.60 | 6.68 | 6.45 |
| Y | 8.25 | 1.83 | 1.64 | 6.62 | 6.42 |
| Z | 8.22 | 1.88 | 1.68 | 6.54 | 6.34 |
| AA | 8.21 | 1.91 | 1.70 | 6.51 | 6.29 |
| AB | 8.23 | 1.95 | 1.73 | 6.50 | 6.28 |
| AC | 8.30 | 1.98 | 1.75 | 6.54 | 6.31 |

The composite airfoil design of Example 4 includes 24 blades, with an Rhub of 8 and an Rtip of 26.5, resulting in a Span of 18.5.

Other composite blade designs did not provide the right balance to benefit durability and engine performance without introducing negative weight and/or damping effects. Tables 3A-3C (Examples 5-7) provide some such example blade designs.

TABLE 3A
Example 5

| Slice | CL | LLP | LLS | CCLS | CCLP |
|---|---|---|---|---|---|
| A | 17.26 | 4.01 | 2.38 | 14.88 | 13.25 |
| B | 17.17 | 3.91 | 2.28 | 14.89 | 13.26 |
| C | 16.49 | 3.78 | 2.15 | 14.34 | 12.71 |
| D | 16.02 | 3.76 | 2.13 | 13.89 | 12.26 |
| E | 15.62 | 3.86 | 2.19 | 13.43 | 11.76 |
| F | 14.97 | 3.96 | 2.28 | 12.69 | 11.01 |
| G | 14.61 | 4.15 | 2.38 | 12.23 | 10.46 |
| H | 14.44 | 4.34 | 2.47 | 11.97 | 10.10 |
| J | 14.66 | 5.15 | 2.66 | 12.00 | 9.51 |
| K | 15.38 | 5.57 | 2.86 | 12.52 | 9.81 |
| L | 16.17 | 5.86 | 3.05 | 13.12 | 10.31 |
| M | 17.63 | 5.91 | 3.23 | 14.40 | 11.72 |
| N | 18.86 | 6.46 | 3.38 | 15.48 | 12.40 |
| P | 20.14 | 6.01 | 3.51 | 16.63 | 14.13 |
| R | 21.12 | 5.68 | 3.63 | 17.49 | 15.44 |
| S | 22.00 | 5.54 | 3.73 | 18.27 | 16.46 |
| T | 22.54 | 5.01 | 3.82 | 18.72 | 17.54 |
| U | 22.73 | 4.65 | 3.91 | 18.83 | 18.09 |
| V | 22.90 | 4.50 | 3.98 | 18.92 | 18.40 |
| W | 22.68 | 4.51 | 4.06 | 18.62 | 18.16 |
| X | 22.44 | 4.58 | 4.13 | 18.31 | 17.85 |
| Y | 22.31 | 4.60 | 4.20 | 18.12 | 17.71 |
| Z | 22.30 | 4.63 | 4.35 | 17.95 | 17.67 |
| AA | 22.25 | 4.69 | 4.60 | 17.65 | 17.56 |
| AB | 22.12 | 4.79 | 4.85 | 17.27 | 17.33 |
| AC | 22.11 | 4.86 | 5.05 | 17.06 | 17.25 |

The composite airfoil design of Example 5 includes 22 blades, with an Rhub of 23.5 and an Rtip of 64.05, resulting in a Span of 40.55.

TABLE 3B
Example 6

| Slice | CL | LLP | LLS | CCLS | CCLP |
|---|---|---|---|---|---|
| A | 8.43 | 2.10 | 1.62 | 6.81 | 6.33 |
| B | 8.49 | 2.10 | 1.66 | 6.84 | 6.39 |
| C | 8.71 | 2.10 | 1.72 | 6.98 | 6.61 |
| D | 9.04 | 2.10 | 1.76 | 7.29 | 6.94 |
| E | 9.42 | 2.20 | 1.81 | 7.61 | 7.22 |
| F | 9.81 | 2.20 | 1.89 | 7.92 | 7.61 |
| G | 10.20 | 2.20 | 1.99 | 8.21 | 8.00 |
| H | 10.37 | 2.30 | 2.09 | 8.28 | 8.07 |
| J | 10.71 | 2.80 | 2.31 | 8.40 | 7.91 |
| K | 11.18 | 3.31 | 2.51 | 8.67 | 7.87 |
| L | 11.90 | 3.63 | 2.65 | 9.25 | 8.27 |
| M | 12.20 | 3.67 | 2.73 | 9.47 | 8.53 |
| N | 12.56 | 3.52 | 2.73 | 9.83 | 9.05 |
| P | 12.84 | 4.01 | 2.67 | 10.17 | 8.84 |
| R | 12.99 | 3.22 | 2.57 | 10.42 | 9.77 |
| S | 13.02 | 3.12 | 2.48 | 10.54 | 9.90 |
| T | 12.98 | 3.03 | 2.41 | 10.57 | 9.95 |
| U | 12.90 | 2.96 | 2.39 | 10.51 | 9.93 |
| V | 12.80 | 2.91 | 2.40 | 10.40 | 9.90 |
| W | 12.72 | 2.50 | 2.42 | 10.30 | 10.22 |
| X | 12.74 | 2.50 | 2.46 | 10.28 | 10.24 |
| Y | 12.69 | 2.30 | 2.52 | 10.18 | 10.39 |
| Z | 12.64 | 2.30 | 2.58 | 10.06 | 10.34 |
| AA | 12.62 | 2.30 | 2.61 | 10.01 | 10.32 |
| AB | 12.66 | 2.30 | 2.65 | 10.01 | 10.36 |
| AC | 12.77 | 2.30 | 2.70 | 10.07 | 10.47 |

The composite airfoil design of Example 6 includes 22 blades, with an Rhub of 11 and an Rtip of 35, resulting in a Span of 24.

TABLE 3C
Example 7

| Slice | CL | LLP | LLS | CCLS | CCLP |
|---|---|---|---|---|---|
| A | 17.55 | 3.98 | 2.86 | 14.69 | 13.58 |
| B | 17.27 | 3.96 | 2.87 | 14.40 | 13.31 |
| C | 16.95 | 3.97 | 2.90 | 14.05 | 12.99 |
| D | 16.72 | 3.98 | 2.93 | 13.79 | 12.73 |
| E | 16.61 | 3.99 | 2.96 | 13.66 | 12.62 |
| F | 16.66 | 4.01 | 2.98 | 13.67 | 12.64 |
| G | 16.84 | 4.03 | 3.01 | 13.83 | 12.81 |
| H | 17.16 | 4.10 | 3.05 | 14.12 | 13.06 |
| J | 17.37 | 4.17 | 3.09 | 14.28 | 13.20 |
| K | 17.75 | 4.42 | 3.17 | 14.59 | 13.33 |
| L | 18.18 | 4.89 | 3.28 | 14.90 | 13.30 |
| M | 18.67 | 5.37 | 3.39 | 15.28 | 13.30 |
| N | 19.41 | 5.58 | 3.50 | 15.91 | 13.83 |
| P | 20.18 | 5.77 | 3.60 | 16.58 | 14.41 |
| R | 21.15 | 5.89 | 3.70 | 17.44 | 15.25 |
| S | 22.01 | 6.02 | 3.81 | 18.20 | 15.99 |
| T | 22.68 | 6.11 | 3.93 | 18.75 | 16.58 |
| U | 23.19 | 6.18 | 4.09 | 19.11 | 17.02 |
| V | 23.61 | 6.15 | 4.15 | 19.46 | 17.46 |
| W | 24.02 | 6.17 | 4.19 | 19.83 | 17.85 |
| X | 24.45 | 6.09 | 4.23 | 20.22 | 18.36 |
| Y | 24.87 | 6.07 | 4.29 | 20.59 | 18.81 |
| Z | 25.07 | 6.08 | 4.34 | 20.73 | 18.99 |
| AA | 25.63 | 6.10 | 4.40 | 21.23 | 19.53 |
| AB | 26.11 | 6.17 | 4.50 | 21.61 | 19.93 |
| AC | 27.09 | 6.24 | 4.59 | 22.50 | 20.85 |
| AD | 28.29 | 6.25 | 4.50 | 23.79 | 22.04 |
| AE | 29.00 | 6.24 | 4.60 | 24.40 | 22.77 |
| AF | 29.24 | 6.23 | 4.60 | 24.64 | 23.01 |
| AG | 26.93 | 6.41 | 4.75 | 22.18 | 20.52 |
| AH | 24.02 | 6.50 | 4.80 | 19.22 | 17.53 |
| AJ | 20.31 | 6.62 | 5.20 | 15.11 | 13.69 |

The composite airfoil design of Example 7 includes 16 blades, with an Rhub of 17 and an Rtip of 66.73, resulting in a Span of 49.73.

The inventive, improved designs developed by the inventors can be characterized according to certain specific relationships between the MLE pressure side chord length LLP and the blade chord length CL. Embodiments developed by the inventors that satisfy these relationships characterize a PMC fan for an indirect drive engine with a bypass ratio of greater than 13:1 that ensures sufficient MLE protection over the entire radial span of the blade while avoiding negative weight effects and maintaining an aerodynamic response of the blade that is dominated by the PMC airfoil.

Referring to FIG. 9C, the airfoil shown as slices or segments indicating span-wise segments of the airfoil. Each of the segments have a fixed, span-wise length and a chord-wise length being the mean length over the corresponding span-wise length. A mean (μ, Mean) of the chord-wise length over the span of the airfoil is xi/N, i=1. N, where i=number of segments (e.g., N=29 for TABLE 4A example). A standard deviation of the chord-wise lengths (σ, STDEV) for the pressure or suction sides of a MLE over the span of the airfoil is σ=√[(Σ(xᵢ−μ)²)/N].

The inventive designs created by the inventors can be unexpectedly characterized by particular relationship and variation between MLE chord length LLP and blade chord length CL. A particular location on the blade, such as around slices (span %) M-K in the example of FIG. 9C, has a significantly longer MLE pressure side chord (measured by LLP) to account for vibration of the blade when impacted. For the ratio of the MLE chord LLP to the blade Chord CL, the maximum ratio (Max) is more than 2 standard deviations above the mean, and the minimum ratio (Min) is less than 1.5 standard deviations below the mean. The small region of the span with the significantly longer LLP drives the number of standard deviations above the mean to be greater than 2. The minimum ratio of the MLE chord length LLP to the blade Chord CL must be maintained close to the mean in order to ensure sufficient MLE protection over the entire radial span of the blade, so the minimum ratio is less than 1.5 standard deviations below the mean. This is reflected in the following expressions:

$$[ Max ( LLP / CL ) - Mean ( LLP / CL ) ] / STDEV ( LLP / CL ) \geq 2. ; and \qquad ( 6 )$$

$$[ Mean ( LLP / CL ) - Min ( LLP / CL ) ] / STDEV ( LLP / CL ) \leq 1.5 . \qquad ( 7 )$$

More particularly, to provide maximum benefit of impact resistance versus weight and vibration, a result of Expression 6 is between 2.0 and 5.0, and a result of Expression 7 is between 0.7 and 1.5. Significant benefit is also provided when the result of Expression 7 is between 0.3 and 1.5.

The embodiments created by the inventors can be further characterized in that a standard deviation of the suction side MLE chord length LLS with respect to the blade chord length CL is less than a standard deviation of the pressure side MLE chord length LLP with respect to the blade chord length CL.

$$STDEV ( LLS / CL ) \leq STDE V ( LLP / CL ) . \qquad ( 8 )$$

Further, looking at the suction side relationships in addition to the pressure side relationships, a ratio of the pressure side MLE chord length LLS to the blade chord CL can be used to further characterize embodiments developed by the inventors:

$$[ Max ( LLS / CL ) - Mean ( LLS / CL ) ] / STDEV ( LLS / CL ) \geq 2. ; and \qquad ( 9 )$$

$$[ Mean ( LLS / CL ) - Min ( LLS / CL ) ] / STDEV ( LLS / CL ) \leq 1.5 . \qquad ( 10 )$$

More particularly, to provide maximum benefit of impact resistance versus weight and vibration, a result of Expression 9 is between 2.0 and 5.0, and a result of Expression 10 is between 0.7 and 1.5. Significant benefit is also provided when the result of Expression 8 is between 0.3 and 1.5.

Expressions 6 and 7, as well as Expressions 8, 9, and 10, unexpectedly characterize the example embodiments 1~4 of Tables 2A-2D, as shown in Tables 4A-4D.

TABLE 4A
Example 1

| Slice | CL | LLP | LLS | LLP/CL | LLS/CL |
|---|---|---|---|---|---|
| A | 17.26 | 4.01 | 2.38 | 0.23 | 0.14 |
| B | 17.17 | 3.91 | 2.28 | 0.23 | 0.13 |
| C | 16.49 | 3.78 | 2.15 | 0.23 | 0.13 |
| D | 16.02 | 3.76 | 2.13 | 0.23 | 0.13 |
| E | 15.62 | 3.82 | 2.19 | 0.24 | 0.14 |
| F | 14.97 | 3.92 | 2.28 | 0.26 | 0.15 |
| G | 14.61 | 4.07 | 2.38 | 0.28 | 0.16 |
| H | 14.44 | 4.25 | 2.47 | 0.29 | 0.17 |
| J | 14.66 | 5.00 | 2.66 | 0.34 | 0.18 |
| K | 15.38 | 5.81 | 2.86 | 0.38 | 0.19 |
| L | 16.17 | 6.80 | 3.05 | 0.42 | 0.19 |
| M | 17.63 | 7.39 | 3.23 | 0.42 | 0.18 |
| N | 18.86 | 6.95 | 3.38 | 0.37 | 0.18 |
| P | 20.14 | 6.61 | 3.51 | 0.33 | 0.17 |
| R | 21.12 | 5.99 | 3.63 | 0.28 | 0.17 |
| S | 22.00 | 5.49 | 3.73 | 0.25 | 0.17 |
| T | 22.54 | 5.01 | 3.82 | 0.22 | 0.17 |
| U | 22.73 | 4.65 | 3.91 | 0.20 | 0.17 |
| V | 22.90 | 4.50 | 3.98 | 0.20 | 0.17 |
| W | 22.68 | 4.56 | 4.06 | 0.20 | 0.18 |
| X | 22.44 | 4.63 | 4.13 | 0.21 | 0.18 |
| Y | 22.31 | 4.70 | 4.20 | 0.21 | 0.19 |
| Z | 22.30 | 5.00 | 4.90 | 0.22 | 0.22 |
| AA | 22.25 | 5.20 | 5.10 | 0.23 | 0.23 |
| AB | 22.12 | 5.30 | 5.20 | 0.24 | 0.24 |
| AC | 22.11 | 5.70 | 5.60 | 0.26 | 0.25 |

The composite airfoil design of Example 1 includes 22 blades, with an Rhub of 23.5 and an Rtip of 64.05, resulting in a Span of 40.55. The value of LLP/CL for Example 1 has a maximum (Max) of 0.42, a minimum (Min) of 0.20, a mean of 0.27, and a STDEV of 0.07. Evaluating Expression 6, (Max−Mean)/STDEV=2.27 (greater than 2.0), and evaluating Expression 7, (Mean−Min)/STDEV=1.08 (less than 1.5).

Further, the value of LLS/CL for Example 1 has a maximum (Max) of 0.25, a minimum (Min) of 0.13, a mean of 0.18, and a STDEV of 0.03. Evaluating Expression 9, (Max−Mean)/STDEV=2.46 (greater than or equal to 2.0), and evaluating Expression 10, (Mean−Min)/STDEV=1.50 (less than or equal to 1.5). Evaluating Expression 8, STDEV (LLS/CL)=0.03<STDEV (LLP/CL)=0.07.

TABLE 4B
Example 2

| Slice | CL | LLP | LLS | LLP/CL | LLS/CL |
|---|---|---|---|---|---|
| A | 8.43 | 1.92 | 1.62 | 0.23 | 0.19 |
| B | 8.49 | 1.96 | 1.66 | 0.23 | 0.20 |
| C | 8.71 | 2.03 | 1.72 | 0.23 | 0.20 |
| D | 9.04 | 2.07 | 1.76 | 0.23 | 0.19 |
| E | 9.42 | 2.13 | 1.81 | 0.23 | 0.19 |
| F | 9.81 | 2.21 | 1.89 | 0.22 | 0.19 |
| G | 10.20 | 2.32 | 1.99 | 0.23 | 0.19 |
| H | 10.37 | 2.47 | 2.09 | 0.24 | 0.20 |
| J | 10.71 | 2.87 | 2.31 | 0.27 | 0.22 |
| K | 11.18 | 3.31 | 2.51 | 0.30 | 0.22 |
| L | 11.73 | 3.63 | 2.65 | 0.31 | 0.23 |
| M | 12.20 | 3.67 | 2.73 | 0.30 | 0.22 |
| N | 12.56 | 3.52 | 2.73 | 0.28 | 0.22 |
| P | 12.84 | 4.01 | 2.67 | 0.31 | 0.21 |
| R | 12.99 | 3.22 | 2.57 | 0.25 | 0.20 |
| S | 13.02 | 3.12 | 2.48 | 0.24 | 0.19 |
| T | 12.98 | 3.03 | 2.41 | 0.23 | 0.19 |
| U | 12.90 | 2.96 | 2.39 | 0.23 | 0.19 |
| V | 12.80 | 2.91 | 2.40 | 0.23 | 0.19 |
| W | 12.72 | 2.85 | 2.42 | 0.22 | 0.19 |
| X | 12.74 | 2.81 | 2.46 | 0.22 | 0.19 |
| Y | 12.69 | 2.81 | 2.52 | 0.22 | 0.20 |
| Z | 12.64 | 2.89 | 2.58 | 0.23 | 0.20 |
| AA | 12.62 | 2.95 | 2.61 | 0.23 | 0.21 |
| AB | 12.66 | 3.00 | 2.65 | 0.24 | 0.21 |
| AC | 12.77 | 3.05 | 2.70 | 0.24 | 0.21 |

The composite airfoil design of Example 2 includes 20 blades, with an Rhub of 11 and an Rtip of 35, resulting in a Span of 24. The value of LLP/CL for Example 2 has a maximum (Max) of 0.31, a minimum (Min) of 0.22, a mean of 0.25, and a STDEV of 0.03. Evaluating Expression 6, (Max−Mean)/STDEV=2.29 (greater than 2.0), and evaluating Expression 7, (Mean−Min)/STDEV=0.87 (less than 1.5).

Further, the value of LLS/CL for Example 2 has a maximum (Max) of 0.23, a minimum (Min) of 0.19, a mean of 0.20, and a STDEV of 0.01. Evaluating Expression 9, (Max−Mean)/STDEV=2.00 (greater than or equal to 2.0), and evaluating Expression 10, (Mean−Min)/STDEV=1.31 (less than 1.5). Evaluating Expression 8, STDEV (LLS/CL)=0.01<STDEV (LLP/CL)=0.03.

TABLE 4C
Example 3

| Slice | CL | LLP | LLS | LLP/CL | LLS/CL |
|---|---|---|---|---|---|
| A | 17.55 | 3.98 | 2.86 | 0.23 | 0.16 |
| B | 17.27 | 3.96 | 2.87 | 0.23 | 0.17 |
| C | 16.95 | 3.97 | 2.90 | 0.23 | 0.17 |
| D | 16.72 | 3.98 | 2.93 | 0.24 | 0.18 |
| E | 16.61 | 3.99 | 2.96 | 0.24 | 0.18 |
| F | 16.66 | 4.01 | 2.98 | 0.24 | 0.18 |
| G | 16.84 | 4.03 | 3.01 | 0.24 | 0.18 |
| H | 17.16 | 4.10 | 3.05 | 0.24 | 0.18 |
| J | 17.37 | 4.17 | 3.09 | 0.24 | 0.18 |
| K | 17.75 | 4.42 | 3.17 | 0.25 | 0.18 |
| L | 18.18 | 4.89 | 3.28 | 0.27 | 0.18 |
| M | 18.67 | 5.37 | 3.39 | 0.29 | 0.18 |
| N | 19.41 | 5.58 | 3.50 | 0.29 | 0.18 |
| P | 20.18 | 5.77 | 3.60 | 0.29 | 0.18 |
| R | 21.15 | 5.89 | 3.70 | 0.28 | 0.18 |
| S | 22.01 | 6.02 | 3.81 | 0.27 | 0.17 |
| T | 22.68 | 6.11 | 3.93 | 0.27 | 0.17 |
| U | 23.19 | 6.18 | 4.09 | 0.27 | 0.18 |
| V | 23.61 | 6.15 | 4.15 | 0.26 | 0.18 |
| W | 24.02 | 6.17 | 4.19 | 0.26 | 0.17 |
| X | 24.45 | 6.09 | 4.23 | 0.25 | 0.17 |
| Y | 24.87 | 6.07 | 4.29 | 0.24 | 0.17 |
| Z | 25.07 | 6.08 | 4.34 | 0.24 | 0.17 |
| AA | 25.63 | 6.10 | 4.40 | 0.24 | 0.17 |
| AB | 26.11 | 6.17 | 4.50 | 0.24 | 0.17 |
| AC | 27.09 | 6.24 | 4.59 | 0.23 | 0.17 |
| AD | 28.29 | 6.30 | 4.72 | 0.22 | 0.17 |
| AE | 29.00 | 6.34 | 4.87 | 0.22 | 0.17 |
| AF | 29.24 | 6.36 | 4.93 | 0.22 | 0.17 |
| AG | 26.93 | 6.41 | 5.03 | 0.24 | 0.19 |
| AH | 24.02 | 6.50 | 5.20 | 0.27 | 0.22 |
| AJ | 20.31 | 6.62 | 5.39 | 0.33 | 0.27 |

The composite airfoil design of Example 3 includes 16 blades, with an Rhub of 17 and an Rtip of 66.73, resulting in a Span of 49.73. The value of LLP/CL for Example 3 has a maximum (Max) of 0.33, a minimum (Min) of 0.22, a mean of 0.25, and a STDEV of 0.02. Evaluating Expression 6, (Max−Mean)/STDEV=3.06 (greater than 2.0), and evaluating Expression 7, (Mean−Min)/STDEV=1.39 (less than 1.5).

Further, the value of LLS/CL for Example 3 has a maximum (Max) of 0.27, a minimum (Min) of 0.16, a mean of 0.18, and a STDEV of 0.02. Evaluating Expression 9, (Max−Mean)/STDEV=4.77 (greater than or equal to 2.0), and evaluating Expression 10, (Mean−Min)/STDEV=0.86 (less than 1.5). Evaluating Expression 8, STDEV (LLS/CL)=0.02=STDEV (LLP/CL)=0.02.

TABLE 4D
Example 4

| Slice | CL | LLP | LLS | LLP/CL | LLS/CL |
|---|---|---|---|---|---|
| A | 5.48 | 1.25 | 1.05 | 0.23 | 0.19 |
| B | 5.52 | 1.28 | 1.08 | 0.23 | 0.20 |
| C | 5.66 | 1.32 | 1.12 | 0.23 | 0.20 |
| D | 5.88 | 1.35 | 1.14 | 0.23 | 0.19 |
| E | 6.13 | 1.38 | 1.18 | 0.23 | 0.19 |
| F | 6.38 | 1.43 | 1.23 | 0.22 | 0.19 |
| G | 6.63 | 1.51 | 1.29 | 0.23 | 0.19 |
| H | 6.74 | 1.61 | 1.36 | 0.24 | 0.20 |
| J | 6.96 | 1.87 | 1.50 | 0.27 | 0.22 |
| K | 7.27 | 2.15 | 1.63 | 0.30 | 0.22 |
| L | 7.62 | 2.36 | 1.72 | 0.31 | 0.23 |
| M | 7.93 | 2.39 | 1.77 | 0.30 | 0.22 |
| N | 8.17 | 2.29 | 1.77 | 0.28 | 0.22 |
| P | 8.35 | 2.25 | 1.74 | 0.27 | 0.21 |
| R | 8.45 | 2.10 | 1.67 | 0.25 | 0.20 |
| S | 8.46 | 2.03 | 1.61 | 0.24 | 0.19 |
| T | 8.44 | 1.97 | 1.57 | 0.23 | 0.19 |
| U | 8.38 | 1.93 | 1.55 | 0.23 | 0.19 |
| V | 8.32 | 1.89 | 1.56 | 0.23 | 0.19 |
| W | 8.27 | 1.86 | 1.57 | 0.22 | 0.19 |
| X | 8.28 | 1.83 | 1.60 | 0.22 | 0.19 |
| Y | 8.25 | 1.83 | 1.64 | 0.22 | 0.20 |
| Z | 8.22 | 1.88 | 1.68 | 0.23 | 0.20 |
| AA | 8.21 | 1.91 | 1.70 | 0.23 | 0.21 |
| AB | 8.23 | 1.95 | 1.73 | 0.24 | 0.21 |
| AC | 8.30 | 1.98 | 1.75 | 0.24 | 0.21 |

The composite airfoil design of Example 4 includes 24 blades, with an Rhub of 8 and an Rtip of 26.5, resulting in a Span of 18.5. The value of LLP/CL for Example 4 has a maximum (Max) of 0.31, a minimum (Min) of 0.22, a mean of 0.24, and a STDEV of 0.03. Evaluating Expression 6, (Max−Mean)/STDEV=2.49 (greater than 2.0), and evaluating Expression 7, (Mean−Min)/STDEV=0.90 (less than 1.5).

Further, the value of LLS/CL for Example 4 has a maximum (Max) of 0.23, a minimum (Min) of 0.19, a mean of 0.20, and a STDEV of 0.01. Evaluating Expression 9, (Max−Mean)/STDEV=2.00 (greater than or equal to 2.0), and evaluating Expression 10, (Mean−Min)/STDEV=1.31 (less than 1.5). Evaluating Expression 8, STDEV (LLS/CL)=0.01<STDEV (LLP/CL)=0.03.

As discussed above, other composite blade designs, such as Examples 5-7, did not provide the right balance to benefit durability and engine performance, reflected in Tables 5A-4C.

TABLE 5A
Example 5

| Slice | CL | LLP | LLS | LLP/CL | LLS/LP |
|---|---|---|---|---|---|
| A | 17.26 | 4.01 | 2.38 | 0.23 | 0.14 |
| B | 17.17 | 3.91 | 2.28 | 0.23 | 0.13 |
| C | 16.49 | 3.78 | 2.15 | 0.23 | 0.13 |
| D | 16.02 | 3.76 | 2.13 | 0.23 | 0.13 |
| E | 15.62 | 3.86 | 2.19 | 0.25 | 0.14 |
| F | 14.97 | 3.96 | 2.28 | 0.26 | 0.15 |
| G | 14.61 | 4.15 | 2.38 | 0.28 | 0.16 |
| H | 14.44 | 4.34 | 2.47 | 0.30 | 0.17 |
| J | 14.66 | 5.15 | 2.66 | 0.35 | 0.18 |
| K | 15.38 | 5.57 | 2.86 | 0.36 | 0.19 |
| L | 16.17 | 5.86 | 3.05 | 0.36 | 0.19 |
| M | 17.63 | 5.91 | 3.23 | 0.34 | 0.18 |
| N | 18.86 | 6.46 | 3.38 | 0.34 | 0.18 |
| P | 20.14 | 6.01 | 3.51 | 0.30 | 0.17 |
| R | 21.12 | 5.68 | 3.63 | 0.27 | 0.17 |
| S | 22.00 | 5.54 | 3.73 | 0.25 | 0.17 |
| T | 22.54 | 5.01 | 3.82 | 0.22 | 0.17 |
| U | 22.73 | 4.65 | 3.91 | 0.20 | 0.17 |
| V | 22.90 | 4.50 | 3.98 | 0.20 | 0.17 |
| W | 22.68 | 4.51 | 4.06 | 0.20 | 0.18 |
| X | 22.44 | 4.58 | 4.13 | 0.20 | 0.18 |
| Y | 22.31 | 4.60 | 4.20 | 0.21 | 0.19 |
| Z | 22.30 | 4.63 | 4.35 | 0.21 | 0.20 |
| AA | 22.25 | 4.69 | 4.60 | 0.21 | 0.21 |
| AB | 22.12 | 4.79 | 4.85 | 0.22 | 0.22 |
| AC | 22.11 | 4.86 | 5.05 | 0.22 | 0.23 |

The composite airfoil design of Example 5 includes 22 blades, with an Rhub of 23.5 and an Rtip of 64.05, resulting in a Span of 40.55. The value of LLP/CL for Example 5 has a maximum (Max) of 0.36, a minimum (Min) of 0.20, a mean of 0.26, and a STDEV of 0.06. Evaluating Expression 6, (Max−Mean)/STDEV=1.91 not greater than or equal to 2.0), and evaluating Expression 7, (Mean−Min)/STDEV 1.1 (less than 1.5). As such, Example 5 does not satisfy the constraint of Expression 6 and is not part of the inventor's beneficial design space of fan blade implementations.

Further, the value of LLS/CL for Example 5 has a maximum (Max) of 0.23, a minimum (Min) of 0.13, a mean of 0.17, and a STDEV of 0.03. Evaluating Expression 9, (Max−Mean)/STDEV=2.19 (greater than or equal to 2.0), and evaluating Expression 10, (Mean−Min)/STDEV=1.72 (not less than 1.5). As such, Example 5 also does not satisfy the constraint of Expression 10 and is not part of the inventor's beneficial design space of fan blade implementations.

TABLE 5B
Example 6

| Slice | CL | LLP | LLS | LLP/CL | LLS/CL |
|---|---|---|---|---|---|
| A | 8.43 | 2.10 | 1.62 | 0.25 | 0.19 |
| B | 8.49 | 2.10 | 1.66 | 0.25 | 0.20 |
| C | 8.71 | 2.10 | 1.72 | 0.24 | 0.20 |
| D | 9.04 | 2.10 | 1.76 | 0.23 | 0.19 |
| E | 9.42 | 2.20 | 1.81 | 0.23 | 0.19 |
| F | 9.81 | 2.20 | 1.89 | 0.22 | 0.19 |
| G | 10.20 | 2.20 | 1.99 | 0.22 | 0.19 |
| H | 10.37 | 2.30 | 2.09 | 0.22 | 0.20 |
| J | 10.71 | 2.80 | 2.31 | 0.26 | 0.22 |
| K | 11.18 | 3.31 | 2.51 | 0.30 | 0.22 |
| L | 11.90 | 3.63 | 2.65 | 0.30 | 0.22 |
| M | 12.20 | 3.67 | 2.73 | 0.30 | 0.22 |
| N | 12.56 | 3.52 | 2.73 | 0.28 | 0.22 |
| P | 12.84 | 4.01 | 2.67 | 0.31 | 0.21 |
| R | 12.99 | 3.22 | 2.57 | 0.25 | 0.20 |
| S | 13.02 | 3.12 | 2.48 | 0.24 | 0.19 |
| T | 12.98 | 3.03 | 2.41 | 0.23 | 0.19 |
| U | 12.90 | 2.96 | 2.39 | 0.23 | 0.19 |
| V | 12.80 | 2.91 | 2.40 | 0.23 | 0.19 |
| W | 12.72 | 2.50 | 2.42 | 0.20 | 0.19 |
| X | 12.74 | 2.50 | 2.46 | 0.20 | 0.19 |
| Y | 12.69 | 2.30 | 2.52 | 0.18 | 0.20 |
| Z | 12.64 | 2.30 | 2.58 | 0.18 | 0.20 |
| AA | 12.62 | 2.30 | 2.61 | 0.18 | 0.21 |
| AB | 12.66 | 2.30 | 2.65 | 0.18 | 0.21 |
| AC | 12.77 | 2.30 | 2.70 | 0.18 | 0.21 |

The composite airfoil design of Example 6 includes 22 blades, with an Rhub of 11 and an Rtip of 35, resulting in a Span of 24. The value of LLP/CL for Example 6 has a maximum (Max) of 0.31, a minimum (Min) of 0.18, a mean of 0.23, and a STDEV of 0.04. Evaluating Expression 6, (Max−Mean)/STDEV=1.93 (not greater than or equal to 2.0), and evaluating Expression 7, (Mean−Min)/STDEV=1.35 (less than 1.5). As such, Example 6 does not satisfy the constraints of both Expressions 6 and 7 and is not part of the inventor's beneficial design space of fan blade implementations

Further, the value of LLS/CL for Example 6 has a maximum (Max) of 0.22, a minimum (Min) of 0.19, a mean of 0.20, and a STDEV of 0.01. Evaluating Expression 9, (Max−Mean)/STDEV=1.92 (not greater than or equal to 2.0), and evaluating Expression 10, (Mean−Min)/STDEV=1.32 (less than 1.5). As such, Example 6 does not satisfy the constraints of both Expressions 9 and 10 and is not part of the inventor's beneficial design space of fan blade implementations.

TABLE 5C
Example 7

| Slice | CL | LLP | LLS | LLP/CL | LLS/CL |
|---|---|---|---|---|---|
| A | 17.55 | 3.98 | 2.86 | 0.23 | 0.16 |
| B | 17.27 | 3.96 | 2.87 | 0.23 | 0.17 |
| C | 16.95 | 3.97 | 2.90 | 0.23 | 0.17 |
| D | 16.72 | 3.98 | 2.93 | 0.24 | 0.18 |
| E | 16.61 | 3.99 | 2.96 | 0.24 | 0.18 |
| F | 16.66 | 4.01 | 2.98 | 0.24 | 0.18 |
| G | 16.84 | 4.03 | 3.01 | 0.24 | 0.18 |
| H | 17.16 | 4.10 | 3.05 | 0.24 | 0.18 |
| J | 17.37 | 4.17 | 3.09 | 0.24 | 0.18 |
| K | 17.75 | 4.42 | 3.17 | 0.25 | 0.18 |
| L | 18.18 | 4.89 | 3.28 | 0.27 | 0.18 |
| M | 18.67 | 5.37 | 3.39 | 0.29 | 0.18 |
| N | 19.41 | 5.58 | 3.50 | 0.29 | 0.18 |
| P | 20.18 | 5.77 | 3.60 | 0.29 | 0.18 |
| R | 21.15 | 5.89 | 3.70 | 0.28 | 0.18 |
| S | 22.01 | 6.02 | 3.81 | 0.27 | 0.17 |
| T | 22.68 | 6.11 | 3.93 | 0.27 | 0.17 |
| U | 23.19 | 6.18 | 4.09 | 0.27 | 0.18 |
| V | 23.61 | 6.15 | 4.15 | 0.26 | 0.18 |
| W | 24.02 | 6.17 | 4.19 | 0.26 | 0.17 |
| X | 24.45 | 6.09 | 4.23 | 0.25 | 0.17 |
| Y | 24.87 | 6.07 | 4.29 | 0.24 | 0.17 |
| Z | 25.07 | 6.08 | 4.34 | 0.24 | 0.17 |
| AA | 25.63 | 6.10 | 4.40 | 0.24 | 0.17 |
| AB | 26.11 | 6.17 | 4.50 | 0.24 | 0.17 |
| AC | 27.09 | 6.24 | 4.59 | 0.23 | 0.17 |
| AD | 28.29 | 6.25 | 4.50 | 0.22 | 0.16 |
| AE | 29.00 | 6.24 | 4.60 | 0.21 | 0.16 |
| AF | 29.24 | 6.23 | 4.60 | 0.21 | 0.16 |
| AG | 26.93 | 6.41 | 4.75 | 0.24 | 0.18 |
| AH | 24.02 | 6.50 | 4.80 | 0.27 | 0.20 |
| AJ | 20.31 | 6.62 | 5.20 | 0.33 | 0.26 |

The composite airfoil design of Example 7 includes 16 blades, with an Rhub of 17 and an Rtip of 66.73, resulting in a Span of 49.73.

The value of LLP/CL for Example 7 has a maximum (Max) of 0.33, a minimum (Min) of 0.21, a mean of 0.25, and a STDEV of 0.03. Evaluating Expression 6, (Max−Mean)/STDEV=3.02 (greater than 2.0), and evaluating Expression 7, (Mean−Min)/STDEV=1.54 (not less than 1.5). As such, Example 7 does not satisfy the constraints of both Expressions 6 and 7 and is not part of the inventor's beneficial design space of fan blade implementations.

Further, the value of LLS/CL for Example 7 has a maximum (Max) of 0.26, a minimum (Min) of 0.16, a mean of 0.18, and a STDEV of 0.02. Evaluating Expression 9, (Max−Mean)/STDEV=4.82 (greater than 2.0), and evaluating Expression 10, (Mean−Min)/STDEV=1.17 (less than 1.5).

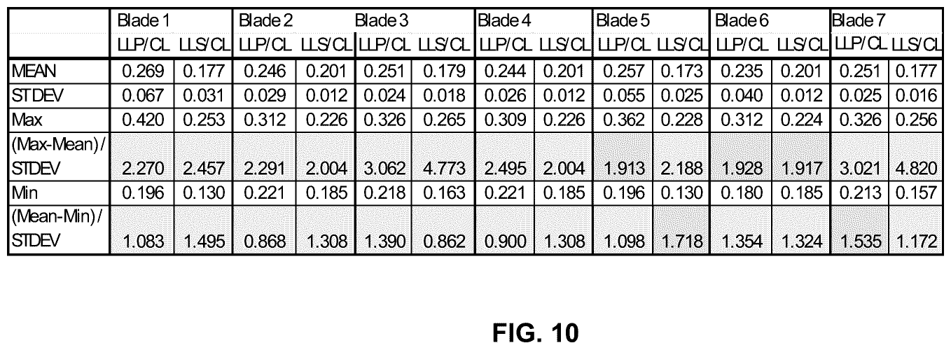

As such, the inventors developed novel composite fan blade designs, as reflected in Tables 2A-2D and 4A-4D, that balance durability to FOD impact, such as a bird strike, with negative damping and weight impacts of placing a metal leading edge protector on a composite airfoil. The examples are summarized in FIG. 10.

As shown in FIG. 10, the example blades 1, 2, 3, and 4 represent inventive designs developed by the inventors, and those designs are characterized by Expressions 6 and 7 above. The example blades 5, 6, 7 are not part of the inventors' inventive designs and cannot be characterized by Expressions 6 and 7 above.

TABLE 6

| | Broad Range | Narrower Range |
|---|---|---|
| LLP | 1.25-7.4 | 1.5-7.4 |
| LLS | 1.05-5.6 | 1.35-5.6 |
| CL | 5.5-30 | 7.0-30 |
| [Max(LLP/CL) − Mean(LLP/CL)]/ | ≥2.0 | 2.0-5.0 |
| STDEV(LLP/CL) | | |
| [Mean(LLP/CL) − Min(LLP/CL)]/ | ≤1.5 | 0.7-1.5 |
| STDEV(LLP/CL) | | |

Embodiments in the narrower range above represent fan blade designs that provide further durability benefit without negatively impacting weight and/or damping in the engine.

To the extent one or more structures provided herein can be known in the art, it should be appreciated that the present disclosure can include combinations of structures not previously known to combine, at least for reasons based in part on conflicting benefits versus losses, desired modes of operation, or other forms of teaching away in the art.

Further aspects are provided by the subject matter of the following clauses:

A gas turbine engine defining a radial direction, the gas turbine engine comprising: a turbomachine comprising a drive turbine and defining a working gas flowpath and an inlet to the working gas flowpath; a fan having a fan blade formed of a composite material, the fan blade defining a leading edge fan radius R_{Fan_LE} and a trailing edge fan radius R_{Fan_TE}, and the fan defining a leading edge hub radius R_{Hub_LE} and a trailing edge hub radius R_{Hub_TE}, the gas turbine engine defining a bypass ratio equal to a mass flowrate of an airflow from the fan over the turbomachine to a mass flowrate of an airflow from the fan through the inlet to the working gas flowpath during operation of the gas turbine engine in a cruise operating mode, the bypass ratio being greater than or equal to 10 and less than or equal to 100; and a reduction gearbox mechanically coupling the drive turbine of the turbomachine to the fan; wherein the gas turbine engine defines a Fan Leading Edge to Trailing Edge Compression Factor (FLTCF) greater than or equal to 1.05 and less than or equal to 1.8, the FLTCF being equal to:

$$\frac{{R}_{Fan \_ LE} \times {R}_{Hub \_ TE}}{{R}_{Fan \_ TE} \times {R}_{Hub \_ LE}} .$$

The gas turbine engine of any preceding clause, wherein the FLTCF is greater than or equal to 1.07 and less than or equal to 1.65.

The gas turbine engine of any preceding clause, wherein the bypass ratio is greater than or equal to 13 and less than or equal to 25.

The gas turbine engine of any preceding clause, wherein the turbomachine comprises a compressor section having a low pressure compressor and a high pressure compressor, wherein the low pressure compressor is rotatable with the drive turbine.

The gas turbine engine of any preceding clause, further comprising: an outer nacelle surrounding at least in part the fan.

The gas turbine engine of any preceding clause, wherein the fan is an unducted fan.

The gas turbine engine of any preceding clause, wherein the leading edge fan radius R_{Fan_LE} is greater than or equal to 65 inches and less than or equal to 85 inches, and wherein the fan defines a fan blade count greater than or equal to 5 and less than or equal to 15.

The gas turbine engine of any preceding clause, wherein the FLTCF is greater than or equal to 1.07 and less than or equal to 1.25.

The gas turbine engine of any preceding clause, wherein the leading edge fan radius R_{Fan_LE} is greater than or equal to 35 inches and less than or equal to 50 inches, wherein the fan defines a fan blade count greater than or equal to 12 and less than or equal to 23, and wherein the reduction gearbox defines a gear ratio between 2:1 and 4:1.

The gas turbine engine of any preceding clause, wherein the FLTCF is greater than or equal to 1.12 and less than or equal to 1.35.

The gas turbine engine of any preceding clause, wherein the gas turbine engine defines a Fan Leading Edge to Trailing Edge Opening Ratio (FLTOR) greater than or equal to 1.03 and less than or equal to 1.5, the FLTOR being equal to:

$$\frac{{R}_{Fan \_ LE} - {R}_{Hub \_ LE}}{{R}_{Fan \_ TE} - {R}_{Hub \_ TE}} .$$

A gas turbine engine defining a radial direction, the gas turbine engine comprising: a turbomachine comprising a drive turbine and defining a working gas flowpath and an inlet to the working gas flowpath; a fan having a fan blade formed of a composite material, the fan blade defining a leading edge fan radius R_{Fan_LE} and a trailing edge fan radius R_{Fan_TE}, and the fan defining a leading edge hub radius R_{Hub_LE} and a trailing edge hub radius R_{Hub_TE}, the gas turbine engine defining a bypass ratio equal to a mass flowrate of an airflow from the fan over the turbomachine to a mass flowrate of an airflow from the fan through the inlet to the working gas flowpath during operation of the gas turbine engine in a cruise operating mode, the bypass ratio being greater than or equal to 10 and less than or equal to 100; and a reduction gearbox mechanically coupling the drive turbine of the turbomachine to the fan; wherein the gas turbine engine defines a Fan Leading Edge to Trailing Edge Opening Ratio (FLTOR) greater than or equal to 1.03 and less than or equal to 1.5, the FLTOR being equal to:

$$\frac{{R}_{Fan \_ LE} - {R}_{Hub \_ LE}}{{R}_{Fan \_ TE} - {R}_{Hub \_ TE}} .$$

The gas turbine engine of any preceding clause, wherein the FLTOR is greater than or equal to 1.05 and less than or equal to 1.3.

The gas turbine engine of any preceding clause, wherein the bypass ratio is greater than or equal to 13 and less than or equal to 25.

The gas turbine engine of any preceding clause, further comprising: an outer nacelle surrounding at least in part the fan.

The gas turbine engine of any preceding clause, wherein the fan is an unducted fan.

The gas turbine engine of any preceding clause, wherein the leading edge fan radius R_{Fan_LE} is greater than or equal to 65 inches and less than or equal to 85 inches, wherein the fan defines a fan blade count greater than or equal to 5 and less than or equal to 15, and wherein the FLTOR is greater than or equal to 1.05 and less than or equal to 1.2.

The gas turbine engine of any preceding clause, wherein the leading edge fan radius R_{Fan_LE} is greater than or equal to 35 inches and less than or equal to 50 inches, wherein the fan defines a fan blade count greater than or equal to 12 and less than or equal to 23, wherein the reduction gearbox defines a gear ratio between 2:1 and 4:1, and wherein the FLTOR is greater than or equal to 1.07 and less than or equal to 1.18.

The gas turbine engine of any preceding clause, wherein the gas turbine engine defines a Fan Leading Edge to Trailing Edge Compression Factor (FLTCF) greater than or equal to 1.05 and less than or equal to 1.8, the FLTCF being equal to:

$$\frac{{R}_{Fan \_ LE} \times {R}_{Hub \_ TE}}{{R}_{Fan \_ TE} \times {R}_{Hub \_ LE}} .$$

The gas turbine engine of any preceding clause, wherein the fan is an unducted fan, wherein the leading edge fan radius R_{Fan_LE} is greater than or equal to 65 inches and less than or equal to 85 inches, wherein the fan defines a fan blade count greater than or equal to 5 and less than or equal to 15, wherein the reduction gearbox defines a gear ratio greater than 4 and less than 12, wherein a thrust rating for the gas turbine engine is between 20,000 pounds and 45,000 pounds, wherein the FLTCF is greater than or equal to 1.07 and less than or equal to 1.25, and wherein the FLTOR is greater than or equal to 1.03 and less than or equal to 1.12.

The gas turbine engine of any preceding clause, wherein the fan is a ducted fan, wherein the leading edge fan radius R_{Fan_LE} is greater than or equal to 35 inches and less than or equal to 50 inches, wherein the fan defines a fan blade count greater than or equal to 12 and less than or equal to 23, wherein the reduction gearbox defines a gear ratio greater than 2 and less than 4, wherein a thrust rating for the gas turbine engine is between 20,000 pounds and 45,000 pounds, wherein the FLTCF is greater than or equal to 1.12 and less than or equal to 1.35, and wherein the FLTOR is greater than or equal to 1.06 and less than or equal to 1.19.

The gas turbine engine of any preceding clause, wherein the fan is a ducted fan, wherein the leading edge fan radius R_{Fan_LE} is greater than or equal to 51 inches and less than or equal to 66 inches, wherein the fan defines a fan blade count greater than or equal to 17 and less than or equal to 23, wherein a thrust rating for the gas turbine engine is between 60,000 pounds and 118,000 pounds, wherein the FLTCF is greater than or equal to 1.27 and less than or equal to 1.5, and wherein the FLTOR is greater than or equal to 1.18 and less than or equal to 1.5.

The gas turbine engine of any preceding clause, wherein the fan is a ducted fan, wherein the leading edge fan radius R_{Fan_LE} is greater than or equal to 55 inches and less than or equal to 70 inches, wherein the fan defines a fan blade count greater than or equal to 12 and less than or equal to 22, wherein a thrust rating for the gas turbine engine is between 100,000 pounds and 150,000 pounds, wherein the FLTCF is greater than or equal to 1.46 and less than or equal to 1.65, and wherein the FLTOR is greater than or equal to 1.2 and less than or equal to 1.5.

A gas turbine engine defining a radial direction, the gas turbine engine comprising: a turbomachine comprising a drive turbine and defining a working gas flowpath and an inlet to the working gas flowpath; a fan having a fan blade formed of a composite material, the fan blade defining a leading edge fan radius R_{Fan_LE} and a trailing edge fan radius R_{Fan_TE}, and the fan defining a leading edge hub radius R_{Hub_LE} and a trailing edge hub radius R_{Hub_TE}, the gas turbine engine defining a bypass ratio equal to a mass flowrate of an airflow from the fan over the turbomachine to a mass flowrate of an airflow from the fan through the inlet to the working gas flowpath during operation of the gas turbine engine in a cruise operating mode, the bypass ratio being greater than or equal to 10 and less than or equal to 100; and a reduction gearbox mechanically coupling the drive turbine of the turbomachine to the fan; wherein the gas turbine engine defines a Fan Leading Edge to Trailing Edge Compression Factor (FLTCF) greater than or equal to 1.05 and less than or equal to 1.8, the FLTCF being equal to:

$$\frac{{R}_{{Fan}_{LE}} \times {R}_{{Hub}_{TE}}}{{R}_{{Fan}_{TE}} \times {R}_{{Hub}_{LE}}} ,$$

wherein the fan blade comprises a composite portion extending chordwise between a composite leading edge and a trailing edge; and a leading edge protector receiving at least a portion of the composite leading edge of the composite portion, the leading edge protector extending chordwise from a leading edge around the composite portion on both a pressure side of the composite portion and a suction side of the composite portion, and wherein the fan blade has a straight line chord length (CL), a leading edge protector chord length on the pressure side (LLP), a leading edge protector chord length on the suction side (LLS), the gas turbine engine has a bypass ratio greater than 13:1, wherein a ratio of LLP to CL moving along the fan blade in a spanwise direction has a maximum [Max(LLP/CL)], a minimum [Min (LLP/CL)], a mean [Mean(LLP/CL)], and a standard deviation [STDEV (LLP/CL)], and wherein [Max(LLP/CL)−Mean(LLP/CL)]/STDEV (LLP/CL)≥2.0; and [Mean(LLP/CL)−Min (LLP/CL)]/STDEV (LLP/CL)≤1.5.

The gas turbine engine of any preceding clause, wherein the FLTCF is greater than or equal to 1.07 and less than or equal to 1.65.

The gas turbine engine of any preceding clause, wherein the bypass ratio is greater than or equal to 13 and less than or equal to 25.

The gas turbine engine of any preceding clause, wherein the fan is an unducted fan.

The gas turbine engine of any preceding clause, wherein the leading edge fan radius R_{Fan_LE} is greater than or equal to 65 inches and less than or equal to 85 inches, and wherein the fan defines a fan blade count greater than or equal to 5 and less than or equal to 15.

The gas turbine engine of any preceding clause, wherein the leading edge fan radius R_{Fan_LE} is greater than or equal to 35 inches and less than or equal to 50 inches, wherein the fan defines a fan blade count greater than or equal to 12 and less than or equal to 23, and wherein the reduction gearbox defines a gear ratio between 2:1 and 4:1.

The gas turbine engine of any preceding clause, wherein the gas turbine engine defines a Fan Leading Edge to Trailing Edge Opening Ratio (FLTOR) greater than or equal to 1.03 and less than or equal to 1.5, the FLTOR being equal to:

$$\frac{{R}_{{Fan}_{LE}} - {R}_{{Hub}_{LE}}}{{R}_{{Fan}_{TE}} - {R}_{{Hub}_{TE}}} .$$

The gas turbine engine of any preceding clause, wherein the FLTOR is greater than or equal to 1.05 and less than or equal to 1.3.

The gas turbine engine of any preceding clause, wherein the leading edge fan radius R_{Fan_LE} is greater than or equal to 65 inches and less than or equal to 85 inches, wherein the fan defines a fan blade count greater than or equal to 5 and less than or equal to 15, and wherein the FLTOR is greater than or equal to 1.05 and less than or equal to 1.2.

The gas turbine engine of any preceding clause, wherein the leading edge fan radius R_{Fan_LE} is greater than or equal to 35 inches and less than or equal to 50 inches, wherein the fan defines a fan blade count greater than or equal to 12 and less than or equal to 23, wherein the reduction gearbox defines a gear ratio between 2:1 and 4:1, and wherein the FLTOR is greater than or equal to 1.07 and less than or equal to 1.18.

The gas turbine engine of any preceding clause, wherein the fan is an unducted fan, wherein the leading edge fan radius R_{Fan_LE} is greater than or equal to 65 inches and less than or equal to 85 inches, wherein the fan defines a fan blade count greater than or equal to 5 and less than or equal to 15, wherein the reduction gearbox defines a gear ratio greater than 4 and less than 12, wherein a thrust rating for the gas turbine engine is between 20,000 pounds and 45,000 pounds, wherein the FLTCF is greater than or equal to 1.07 and less than or equal to 1.25, and wherein the FLTOR is greater than or equal to 1.03 and less than or equal to 1.12.

The gas turbine engine of any preceding clause, wherein the composite portion includes a polymer matrix composite (PMC).

The gas turbine engine of any preceding clause, wherein the leading edge protector is a metallic leading edge protector.

The gas turbine engine of any preceding clause, wherein the fan blade has a chord length pressure side (CCLP) representing a first chordwise length of the composite portion on the pressure side of the fan blade that is not covered by the leading edge protector, and wherein the fan blade has a chord length suction side (CCLS) representing a second chordwise length of the composite portion on the suction side of the fan blade that is not covered by the leading edge protector.

The gas turbine engine of any preceding clause, wherein: 2.0≤[Max(LLP/CL)−Mean(LLP/CL)]/STDEV (LLP/CL)≤5.0; and 0.3≤[Mean(LLP/CL)−Min (LLP/CL)]/STDEV (LLP/CL)≤1.5.

The gas turbine engine of any preceding clause, wherein 0.7≤[Mean(LLP/CL)−Min (LLP/CL)]/STDEV (LLP/CL)≤1.5.

The gas turbine engine of any preceding clause, wherein a ratio of LLS to CL moving along the fan blade in the spanwise direction has a maximum [Max (LLS/CL)], a minimum [Min (LLS/CL)], a mean [Mean (LLS/CL)], and a standard deviation [STDEV (LLS/CL)], wherein [Max (LLS/CL)−Mean (LLS/CL)]/STDEV (LLS/CL)≥2.0; and [Mean (LLS/CL)−Min (LLS/CL)]/STDEV (LLS/CL)≤1.5.

The gas turbine engine of any preceding clause, wherein: 2.0≤[Max (LLS/CL)−Mean (LLS/CL)]/STDEV (LLS/CL)≤5.0; and 0.3≤[Mean (LLS/CL)−Min (LLS/CL)]/STDEV (LLS/CL)≤1.5.

The gas turbine engine of any preceding clause, wherein 0.7≤[Mean (LLS/CL)−Min (LLS/CL)]/STDEV (LLS/CL)≤1.5.

The gas turbine engine of any preceding clause, wherein: STDEV (LLS/CL)≤STDEV (LLP/CL).

A gas turbine engine defining a radial direction, the gas turbine engine comprising: a turbomachine comprising a drive turbine and defining a working gas flowpath and an inlet to the working gas flowpath; a fan having a fan blade formed of a composite material, the fan blade defining a leading edge fan radius R_{Fan_LE} and a trailing edge fan radius R_{Fan_TE}, and the fan defining a leading edge hub radius R_{Hub_LE} and a trailing edge hub radius R_{Hub_TE}, the gas turbine engine defining a bypass ratio equal to a mass flowrate of an airflow from the fan over the turbomachine to a mass flowrate of an airflow from the fan through the inlet to the working gas flowpath during operation of the gas turbine engine in a cruise operating mode, the bypass ratio being greater than or equal to 10 and less than or equal to 100; and a reduction gearbox mechanically coupling the drive turbine of the turbomachine to the fan; wherein the gas turbine engine defines a Fan Leading Edge to Trailing Edge Opening Ratio (FLTOR) greater than or equal to 1.03 and less than or equal to 1.5, the FLTOR being equal to:

$$\frac{{R}_{{Fan}_{LE}} - {R}_{{Hub}_{LE}}}{{R}_{{Fan}_{TE}} - {R}_{{Hub}_{TE}}} ,$$

wherein the fan blade comprises a composite portion extending chordwise between a composite leading edge and a trailing edge; and a leading edge protector receiving at least a portion of the composite leading edge of the composite portion, the leading edge protector extending chordwise from a leading edge around the composite portion on both a pressure side of the composite portion and a suction side of the composite portion, and wherein the fan blade has a straight line chord length (CL), a leading edge protector chord length on the pressure side (LLP), a leading edge protector chord length on the suction side (LLS), the gas turbine engine has a bypass ratio greater than 13:1, wherein a ratio of LLP to CL moving along the fan blade in a spanwise direction has a maximum [Max(LLP/CL)], a minimum [Min (LLP/CL)], a mean [Mean(LLP/CL)], and a standard deviation [STDEV (LLP/CL)], and wherein [Max(LLP/CL)−Mean(LLP/CL)]/STDEV (LLP/CL)≥2.0; and [Mean(LLP/CL)−Min (LLP/CL)]/STDEV (LLP/CL)≤1.5. The gas turbine engine of any preceding clause, wherein the FLTOR is greater than or equal to 1.05 and less than or equal to 1.3.

The gas turbine engine of any preceding clause, wherein the bypass ratio is greater than or equal to 13 and less than or equal to 25.

The gas turbine engine of any preceding clause, wherein the fan is an unducted fan.

The gas turbine engine of any preceding clause, wherein the leading edge fan radius R_{Fan_LE} is greater than or equal to 65 inches and less than or equal to 85 inches, wherein the fan defines a fan blade count greater than or equal to 5 and less than or equal to 15, and wherein the FLTOR is greater than or equal to 1.05 and less than or equal to 1.2.

The gas turbine engine of any preceding clause, wherein the leading edge fan radius R_{Fan_LE} is greater than or equal to 35 inches and less than or equal to 50 inches, wherein the fan defines a fan blade count greater than or equal to 12 and less than or equal to 23, wherein the reduction gearbox defines a gear ratio between 2:1 and 4:1, and wherein the FLTOR is greater than or equal to 1.07 and less than or equal to 1.18.

The gas turbine engine of any preceding clause, wherein the gas turbine engine defines a Fan Leading Edge to Trailing Edge Compression Factor (FLTCF) greater than or equal to 1.05 and less than or equal to 1.8, the FLTCF being equal to:

$$\frac{{R}_{{Fan}_{LE}} \times {R}_{{Hub}_{TE}}}{{R}_{{Fan}_{TE}} \times {R}_{{Hub}_{LE}}} .$$

The gas turbine engine of any preceding clause, wherein the fan is an unducted fan, wherein the leading edge fan radius R_{Fan_LE} is greater than or equal to 65 inches and less than or equal to 85 inches, wherein the fan defines a fan blade count greater than or equal to 5 and less than or equal to 15, wherein the reduction gearbox defines a gear ratio greater than 4 and less than 12, wherein a thrust rating for the gas turbine engine is between 20,000 pounds and 45,000 pounds, wherein the FLTCF is greater than or equal to 1.07 and less than or equal to 1.25, and wherein the FLTOR is greater than or equal to 1.03 and less than or equal to 1.12.

The gas turbine engine of any preceding clause, wherein the composite portion includes a polymer matrix composite (PMC).

The gas turbine engine of any preceding clause, wherein the leading edge protector is a metallic leading edge protector.

The gas turbine engine of any preceding clause, wherein the fan blade has a chord length pressure side (CCLP) representing a first chordwise length of the composite portion on the pressure side of the fan blade that is not covered by the leading edge protector, and wherein the fan blade has a chord length suction side (CCLS) representing a second chordwise length of the composite portion on the suction side of the fan blade that is not covered by the leading edge protector.

The gas turbine engine of any preceding clause, wherein: 2.0≤[Max(LLP/CL)−Mean(LLP/CL)]/STDEV (LLP/CL)≤5.0; and 0.3≤[Mean(LLP/CL)−Min (LLP/CL)]/STDEV (LLP/CL)≤1.5.

The gas turbine engine of any preceding clause, wherein 0.7≤[Mean(LLP/CL)−Min (LLP/CL)]/STDEV (LLP/CL)≤1.5.

The gas turbine engine of any preceding clause, wherein a ratio of LLS to CL moving along the fan blade in the spanwise direction has a maximum [Max (LLS/CL)], a minimum [Min (LLS/CL)], a mean [Mean (LLS/CL)], and a standard deviation [STDEV (LLS/CL)], wherein [Max (LLS/CL)−Mean (LLS/CL)]/STDEV (LLS/CL)≥2.0; and [Mean (LLS/CL)−Min (LLS/CL)]/STDEV (LLS/CL)≤1.5.

The gas turbine engine of any preceding clause, wherein: 2.0< [Max (LLS/CL)−Mean (LLS/CL)]/STDEV (LLS/CL)≤5.0; and 0.3≤[Mean (LLS/CL)−Min (LLS/CL)]/STDEV (LLS/CL)≤1.5.

The gas turbine engine of any preceding clause, wherein 0.7≤[Mean (LLS/CL)−Min (LLS/CL)]/STDEV (LLS/CL)≤1.5.

The gas turbine engine of any preceding clause, wherein: STDEV (LLS/CL)≤STDEV (LLP/CL).

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

We claim:

1. A gas turbine engine defining a radial direction, the gas turbine engine comprising:
a turbomachine comprising a drive turbine and defining a working gas flowpath and an inlet to the working gas flowpath;
a fan having a fan blade formed of a composite material, the fan blade defining a leading edge fan radius R_{Fan_LE} and a trailing edge fan radius R_{Fan_TE}, and the fan defining a leading edge hub radius R_{Hub_LE} and a trailing edge hub radius R_{Hub_TE}, the gas turbine engine defining a bypass ratio equal to a mass flowrate of an airflow from the fan over the turbomachine to a mass flowrate of an airflow from the fan through the inlet to the working gas flowpath during operation of the gas turbine engine in a cruise operating mode, the bypass ratio being greater than or equal to 10 and less than or equal to 100; and
a reduction gearbox mechanically coupling the drive turbine of the turbomachine to the fan;
wherein the gas turbine engine defines a Fan Leading Edge to Trailing Edge Compression Factor (FLTCF) greater than or equal to 1.05 and less than or equal to 1.8, the FLTCF being equal to:
$$\frac{{R}_{{Fan}_{LE}} \times {R}_{{Hub}_{TE}}}{{R}_{{Fan}_{TE}} \times {R}_{{Hub}_{LE}}} ,$$
wherein the fan blade comprises a composite portion extending chordwise between a composite leading edge and a trailing edge; and a leading edge protector receiving at least a portion of the composite leading edge of the composite portion, the leading edge protector extending chordwise from a leading edge around the composite portion on both a pressure side of the composite portion and a suction side of the composite portion, and
wherein the fan blade has a straight line chord length (CL), a leading edge protector chord length on the pressure side (LLP), a leading edge protector chord length on the suction side (LLS), the gas turbine engine has a bypass ratio greater than 13:1,
wherein a ratio of LLP to CL moving along the fan blade in a spanwise direction has a maximum [Max(LLP/CL)], a minimum [Min (LLP/CL)], a mean [Mean(LLP/CL)], and a standard deviation [STDEV (LLP/CL)], and
wherein [Max(LLP/CL)−Mean(LLP/CL)]/STDEV (LLP/CL)≥2.0; and [Mean(LLP/CL)−Min (LLP/CL)]/STDEV (LLP/CL)≤1.5.

2. The gas turbine engine of claim 1, wherein the FLTCF is greater than or equal to 1.07 and less than or equal to 1.65.

3. The gas turbine engine of claim 1, wherein the bypass ratio is greater than or equal to 13 and less than or equal to 25.

4. The gas turbine engine of claim 1, wherein the fan is an unducted fan.

5. The gas turbine engine of claim 1, wherein the leading edge fan radius R_{Fan_LE} is greater than or equal to 65 inches and less than or equal to 85 inches, and wherein the fan defines a fan blade count greater than or equal to 5 and less than or equal to 15.

6. The gas turbine engine of claim 1, wherein the leading edge fan radius R_{Fan_LE} is greater than or equal to 35 inches and less than or equal to 50 inches, wherein the fan defines a fan blade count greater than or equal to 12 and less than or equal to 23, and wherein the reduction gearbox defines a gear ratio between 2:1 and 4:1.

7. The gas turbine engine of claim 1, wherein the gas turbine engine defines a Fan Leading Edge to Trailing Edge Opening Ratio (FLTOR) greater than or equal to 1.03 and less than or equal to 1.5, the FLTOR being equal to:
$$\frac{{R}_{{Fan}_{LE}} - {R}_{{Hub}_{LE}}}{{R}_{{Fan}_{TE}} - {R}_{{Hub}_{TE}}} .$$

8. The gas turbine engine of claim 7, wherein the FLTOR is greater than or equal to 1.05 and less than or equal to 1.3.

9. The gas turbine engine of claim 8, wherein the leading edge fan radius R_{Fan_LE} is greater than or equal to 65 inches and less than or equal to 85 inches, wherein the fan defines a fan blade count greater than or equal to 5 and less than or equal to 15, and wherein the FLTOR is greater than or equal to 1.05 and less than or equal to 1.2.

10. The gas turbine engine of claim 7, wherein the leading edge fan radius R_{Fan_LE} is greater than or equal to 35 inches and less than or equal to 50 inches, wherein the fan defines a fan blade count greater than or equal to 12 and less than or equal to 23, wherein the reduction gearbox defines a gear ratio between 2:1 and 4:1, and wherein the FLTOR is greater than or equal to 1.07 and less than or equal to 1.18.

11. The gas turbine engine of claim 7, wherein the fan is an unducted fan, wherein the leading edge fan radius R_{Fan_LE} is greater than or equal to 65 inches and less than or equal to 85 inches, wherein the fan defines a fan blade count greater than or equal to 5 and less than or equal to 15, wherein the reduction gearbox defines a gear ratio greater than 4 and less than 12, wherein a thrust rating for the gas turbine engine is between 20,000 pounds and 45,000 pounds, wherein the FLTCF is greater than or equal to 1.07 and less than or equal to 1.25, and wherein the FLTOR is greater than or equal to 1.03 and less than or equal to 1.12.

12. The gas turbine engine of claim 1, wherein the composite portion includes a polymer matrix composite (PMC).

13. The gas turbine engine of claim 12, wherein the leading edge protector is a metallic leading edge protector.

14. The gas turbine engine of claim 1, wherein the fan blade has a chord length pressure side (CCLP) representing a first chordwise length of the composite portion on the pressure side of the fan blade that is not covered by the leading edge protector, and wherein the fan blade has a chord length suction side (CCLS) representing a second chordwise length of the composite portion on the suction side of the fan blade that is not covered by the leading edge protector.

15. The gas turbine engine of claim 1, wherein:
$$2. \leq [ Max ( LLP / CL ) - Mean ( LLP / CL ) ] / STDEV ( LLP / CL ) \leq 5. ; and$$
$$0.3 \leq [ Mean ( LLP / CL ) - Min ( LLP / CL ) ] / STDEV ( LLP / CL ) \leq 1.5 .$$

16. The gas turbine engine of claim 1, wherein 0.7≤[Mean(LLP/CL)−Min (LLP/CL)]/STDEV (LLP/CL)≤1.5.

17. The gas turbine engine of claim 1, wherein a ratio of LLS to CL moving along the fan blade in the spanwise direction has a maximum [Max (LLS/CL)], a minimum [Min (LLS/CL)], a mean [Mean (LLS/CL)], and a standard deviation [STDEV (LLS/CL)], wherein [Max (LLS/CL)−Mean (LLS/CL)]/STDEV (LLS/CL)≥2.0; and [Mean (LLS/CL)−Min (LLS/CL)]/STDEV (LLS/CL)≤1.5.

18. The gas turbine engine of claim 17, wherein:
$$2. \leq [ Max ( LLS / CL ) - Mean ( LLS / CL ) ] / STDEV ( LLS / CL ) \leq 5. ; and$$
$$0.3 \leq [ Mean ( LLS / CL ) - Min ( LLS / CL ) ] / STDEV ( LLS / CL ) \leq 1.5 .$$

19. The gas turbine engine of claim 17, wherein 0.7≤[Mean (LLS/CL)−Min (LLS/CL)]/STDEV (LLS/CL)≤1.5.

20. The gas turbine engine of claim 17, wherein: STDEV (LLS/CL)≤STDEV (LLP/CL).
